(19) United States
(12) Patent Application Publication
(10) Pub. No.: US 2012/0145134 A1
(43) Pub. Date: Jun. 14, 2012

(54) EXHAUST GAS RECIRCULATION SYSTEM

(75) Inventors: Shinsuke Miyazaki, Chiryu-city (JP); Koji Hashimoto, Anjo-city (JP); Takaaki Oohashi, Iwakura-city (JP); Kazushi Sasaki, Obu-city (JP); Yuichiro Moritani, Kariya-city (JP)

(73) Assignee: DENSO CORPORATION, Kariya-city (JP)

(21) Appl. No.: 13/308,717

(22) Filed: Dec. 1, 2011

(30) Foreign Application Priority Data
Dec. 9, 2010 (JP) 2010-274687
Feb. 25, 2011 (JP) 2011-39736

(51) Int. Cl. F02M 25/07

(52) U.S. Cl. 123/568.2

(57) ABSTRACT

An exhaust gas recirculation system includes a housing, first and second valves, an actuator, a cam member coupled with the first valve to be in synchronization therewith and receiving power of the actuator to rotate, and a link member coupled with the second valve to be in synchronization therewith and receiving power of the actuator through the cam member to rotate. The cam member includes a cam groove, an open end part formed on one end side of the groove in its formation direction and opening outward of the cam member, and an overlapping part overlapping with the actuator. The link member is driven to rotate along the groove in synchronization with rotation of the cam member. The link member includes a roller guided along the groove.

### CROSS REFERENCE TO RELATED APPLICATION

This application is based on and incorporates herein by reference Japanese Patent Application No. 2010-274687 filed on Dec. 9, 2010, and Japanese Patent Application No. 2011-039736 filed on Feb. 25, 2011.

### BACKGROUND OF THE INVENTION

1. Field of the Invention

The present invention relates generally to an exhaust system for an internal combustion engine that controls exhaust gas of the engine. In particular, the present invention relates to an exhaust gas recirculation (EGR) system that recirculates (returns) EGR gas, which is a part of exhaust gas of the engine, from an exhaust passage to an intake passage.

2. Description of Related Art

Conventionally, there is a widely-known exhaust gas recirculation system (EGR system) having an exhaust gas recirculation pipe (EGR pipe) that recirculates (returns) EGR gas, which is a part of exhaust gas from an exhaust passage to an intake passage, in order to reduce harmful substances (e.g., nitrogen oxide: NOx) contained in exhaust gas discharged from a combustion chamber of an internal combustion engine such as a diesel engine. A structure provided with both a high-pressure loop EGR system, which takes out a part (EGR gas) of exhaust gas from the exhaust passage on an upstream side of a turbine of a turbocharger, and a low-pressure loop EGR system, which takes out EGR gas from the exhaust passage on a downstream side of the turbine, tends to be used for this EGR system.

The reason for provision of both the high-pressure loop EGR system and the low-pressure loop EGR system for one engine is that a sufficient flow rate of EGR gas (EGR amount) may not be ensured due to an increase of pressure of air suctioned by supercharging of the turbocharger at the time of high load only by the high-pressure loop EGR system. In low and middle load areas of the engine, intake air pressure (supercharging pressure) in an intake manifold is lower than exhaust gas pressure in an exhaust manifold, and a differential pressure between both the manifolds is great. Accordingly, relatively much EGR gas can be recirculated by the high-pressure loop EGR system. However, in the engine high load range, the intake air pressure in the intake manifold increases because of the supercharging of the turbocharger, so that the differential pressure between both the manifolds becomes small. Thus, EGR gas cannot be easily recirculated only by the high-pressure loop EGR system. On the other hand, the low-pressure loop EGR system is not affected by the increase of the intake air pressure due to the supercharging of the turbocharger. Therefore, a sufficient flow rate of EGR gas can be secured even at the time of the high load.

The low-pressure loop EGR system recirculates EGR gas from the exhaust passage on the downstream side of the turbine of the turbocharger through the EGR pipe into the intake passage on an upstream side of a compressor of the turbocharger. Accordingly, the low-pressure loop EGR system is suitable for the case of recirculation of a small amount of EGR gas, but unsuitable for the case of recirculation of a large amount of EGR gas. For this reason, the large amount of EGR gas cannot be introduced into the engine combustion chamber using the low-pressure loop EGR system to further improve exhaust gas performance. As a result, in the low-pressure loop EGR system, an intake throttle valve may be provided in the intake passage on an upstream side of a merging part between the EGR pipe and the intake air pipe. In an operating range in which the large amount of EGR gas is recirculated using the low-pressure loop EGR system, a differential pressure between the exhaust passage side and intake passage side may be made large by closing the intake throttle valve. In addition, an EGR control valve that adjusts the flow rate of EGR gas by its opening and closing operation is disposed in the EGR pipe. As described above, in the low-pressure loop EGR system having the EGR control valve and the intake throttle valve, an actuator which drives the EGR control valve and an actuator which drives the intake throttle valve are necessary. Thus, because two actuators are required, a cost rise is caused.

Consequently, a low-pressure loop EGR system that drives the EGR control valve and the intake throttle valve by a single actuator is proposed (see, for example, JP-A-2010-190116). In this low-pressure loop EGR system, the EGR control valve is supported by and fixed to an intermediate part of a drive shaft of the single electric actuator, and a cam plate is coupled with an end of this drive shaft; a roller is inserted movably into a cam groove of the cam plate, and an arm having a holding pin, which supports this roller, is disposed; and a driven shaft is fixed to this arm, and the intake throttle valve is supported and fixed by the driven shaft, so that the drive shaft and driven shaft are coupled and synchronized via the cam plate, roller, and arm. Accordingly, the EGR control valve and the intake throttle valve, which have different operation patterns, are driven by the single actuator.

Defects of the conventional technology will be described. In the conventional low-pressure loop EGR system, the size of the cam plate is large, since it has a shape that surrounds the whole circumference of the cam groove in order to prevent separation of the roller, which is supported by the holding pin of the arm, from the cam groove. As a result, a problem that the size of the entire system becomes large to ensure a space for disposing the cam plate, and that the installability of the system in a vehicle such as an automobile is reduced, is caused. FIGS. 15 and 16 illustrate a low-pressure loop EGR system (comparative example) that the inventors have produced by way of trial and examined and that drives two first and second valves 101, 102 with different operation patterns by a single electric actuator. The first valve 101 is a valving element of an EGR control valve, and the second valve 102 is a valving element of an intake throttle valve.

A valve unit used for this low-pressure loop EGR system includes the two first and second valves 101, 102, a valve housing 103, a cam plate 104, a linking lever 105, a pivot pin 106, a roller 107, the electric actuator, and a motor housing 108. The electric actuator includes an electric motor 113 which generates driving force for driving respective rotatable shafts 111, 112 of the two first and second valves 101, 102, and a deceleration mechanism (three gears 114 to 116) that decelerates the rotation of this electric motor 113 through two stages. The gear 116 is fixed to an outer peripheral part of the cam plate 104. An EGR gas introduction passage 121, an intake air introduction passage 122, a merging part 123, and a communication passage 124 are formed in the valve housing 103.

The cam plate 104 includes a cam base 131 that receives motor torque from the final gear 116 to be rotated together with the rotatable shaft 111 of the first valve 101, a cam frame 132 which transmits the motor torque to the linking lever 105, and a cam groove 133 formed in this cam frame 132. The linking lever 105 receives the motor torque from the cam frame 132 to rotate together with the rotatable shaft 112 of the second valve 102. The pivot pin 106 is fixed to the linking lever 105. The roller 107 is supported rotatably by the pivot pin 106 and guided along the cam groove 133 of the cam frame 132.

In the above-described valve unit, similar to JP-A-2010-190116, the cam plate 104 is formed in a shape that surrounds the whole circumference of the cam groove 133, and the size of the cam plate 104 is thereby made large. Accordingly, the size of the entire low-pressure loop EGR system is made large to ensure a space for disposing the cam plate 104. When the first valve 101, which is a valving element of the EGR control valve, is located near its fully closed position, as illustrated in FIG. 15, the cam plate 104 and the electric actuator (particularly the gear 116) overlap. A clearance (spatial allowance) in the rotation axis direction that is needed to prevent the interference between the cam plate 104 and the electric actuator is very narrow, and there is concern that the cam plate 104 and the electric actuator interfere with each other. As a result, the size of the entire low-pressure loop EGR system needs to be made even larger in order to increase the allowance for the interference between the cam plate 104 and the electric actuator. Therefore, in accordance with the grow in size of the entire low-pressure loop EGR system, further deterioration of the installability of the valve unit can be caused.

### SUMMARY OF THE INVENTION

The present invention addresses at least one of the above disadvantages.

According to the present invention, there is provided an exhaust gas recirculation system adapted for an internal combustion engine, for mixing exhaust gas of the engine into intake air and for recirculating mixed gas of the intake air and the exhaust gas to the engine. The system includes a housing, first and second valves, an actuator, a cam member, and a link member. The housing includes first and second passages, a communication passage, and a merging part which merges the first and second passages into the communication passage. The first and second valves are accommodated rotatably in the housing and are configured to open or close the first and second passages, respectively. The actuator is configured to drive the first and second valves to open or close the first and second passages, respectively. The cam member is coupled with the first valve to be in synchronization therewith and receives power of the actuator thereby to rotate. The link member is coupled with the second valve to be in synchronization therewith and receives the power of the actuator through the cam member thereby to rotate. The cam member includes a cam groove, an open end part, and an overlapping part. The link member is driven to rotate along the cam groove in synchronization with the rotation of the cam member. The link member includes a roller that is guided along the cam groove. The open end part is formed on one end side of the cam groove in its formation direction and opens outward of the cam member. The overlapping part overlaps with the actuator. The open end part is formed as a result of elimination of a part unnecessary for movement of the second valve from the overlapping part.

According to the present invention, there is also provided an exhaust system for an internal combustion engine, including a housing, first and second valves, an actuator, a cam member, and a link member. The housing includes first and second passages, a communication passage, and a merging part which merges the first and second passages into the communication passage. At least one of the first and second passages communicates with an exhaust passage of the engine. The first and second valves are accommodated rotatably in the housing and are configured to open or close the first and second passages, respectively. The actuator includes a motor and a deceleration mechanism. The motor is a power source for driving the first and second valves. The deceleration mechanism is configured to decelerate rotation of an output shaft of the motor and includes a motor gear, an intermediate gear, and a final gear. The motor gear is coupled to the output shaft of the motor to be rotatable integrally therewith. The intermediate gear is engaged with the motor gear thereby to rotate. The final gear is engaged with the intermediate gear thereby to rotate. The cam member is coupled with the first valve to be in synchronization therewith and receives power of the motor from the deceleration mechanism thereby to rotate. The link member is coupled with the second valve to be in synchronization therewith and receives the power of the motor through the cam member thereby to rotate. The cam member includes a cam base, a cam frame, and a cam groove. The cam base is located to be rotatable integrally with the final gear and receives the power of the motor from the final gear thereby to rotate together with the first valve. The cam frame is configured to transmit the power of the motor to the link member and includes an overlapping part that overlaps with the motor or the motor gear. The cam groove is formed inside the cam frame. The link member is driven to rotate along the cam groove in synchronization with the rotation of the cam member. The link member includes a roller that is guided along the cam groove. The cam frame is formed as a result of elimination of at least a part unnecessary for movement of the second valve from the overlapping part.

### BRIEF DESCRIPTION OF THE DRAWINGS

The invention, together with additional objectives, features and advantages thereof, will be best understood from the following description, the appended claims and the accompanying drawings in which:

FIG. 1 is a sectional view illustrating a valve module of an exhaust gas recirculation system (low-pressure loop EGR system) in accordance with a first embodiment of the invention;

FIG. 2 is a diagram illustrating the valve module in accordance with the first embodiment;

FIG. 3 is a diagram illustrating the valve module in accordance with the first embodiment;

FIG. 4 is a diagram illustrating the valve module in accordance with the first embodiment;

FIG. 5 is a diagram illustrating the valve module in accordance with the first embodiment;

FIG. 6A is a diagram illustrating a valve module in accordance with a second embodiment of the invention;

FIG. 6B is an arrow view from a direction VIB in FIG. 6A;

FIG. 7 is a diagram illustrating a valve module in accordance with a third embodiment of the invention;

FIG. 8 is a sectional view illustrating a valve module of an exhaust gas recirculation system (low-pressure loop EGR system) in accordance with a fourth embodiment of the invention;

FIG. 9 is a diagram illustrating the valve module in accordance with the fourth embodiment;

FIG. 10 is a diagram illustrating the valve module in accordance with the fourth embodiment;

FIG. 11 is a diagram illustrating the valve module in accordance with the fourth embodiment;

FIG. 12 is a diagram illustrating the valve module in accordance with the fourth embodiment;

FIG. 13 is a diagram illustrating the valve module in accordance with the fourth embodiment;

FIG. 14 is a diagram illustrating a valve module in accordance with a fifth embodiment of the invention;

FIG. 15 is a diagram illustrating a valve unit of an exhaust gas recirculation system (low-pressure loop EGR system) in accordance with a comparative example; and

FIG. 16 is a diagram illustrating the valve unit of the exhaust gas recirculation system (low-pressure loop EGR system) in accordance with the comparative example.

### DETAILED DESCRIPTION OF THE INVENTION

Embodiments of the invention will be described in detail below with reference to the accompanying drawings. The invention configures and achieves the purpose of decreasing a cam member in size to prevent the interference between the cam member and an actuator (e.g., component of a power transmission mechanism) and eventually to decrease the entire system in size, by eliminating (removing) an unnecessary cam groove portion of the part of the cam member overlapping with the actuator at an open end part of the cam member (or cam groove), into which a roller does not enter over the entire operating range (entire moving range) of a second valve.

### First Embodiment

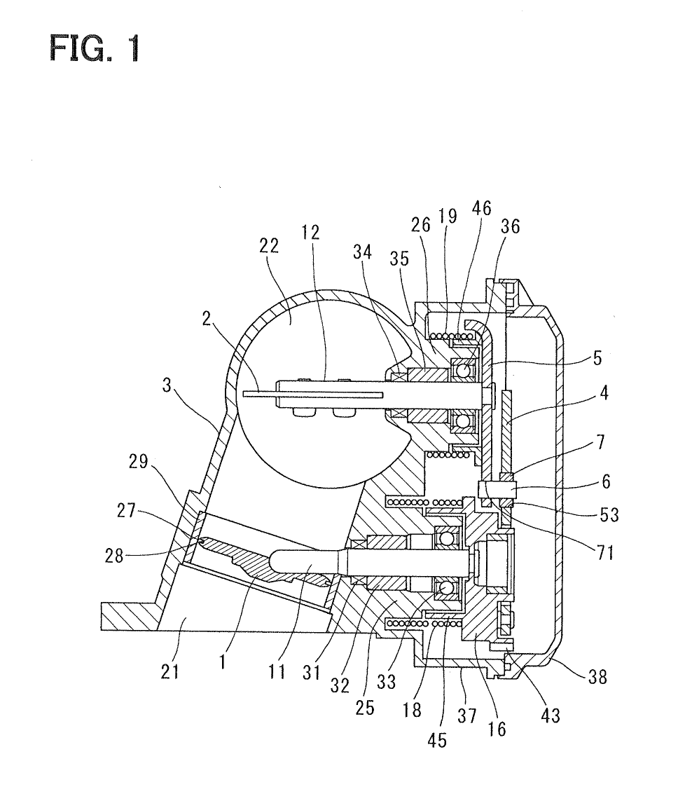

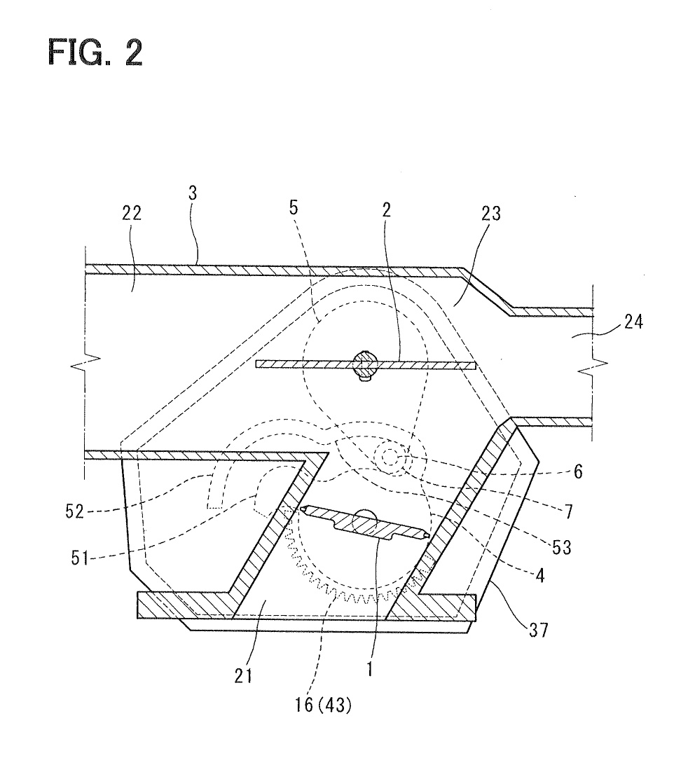

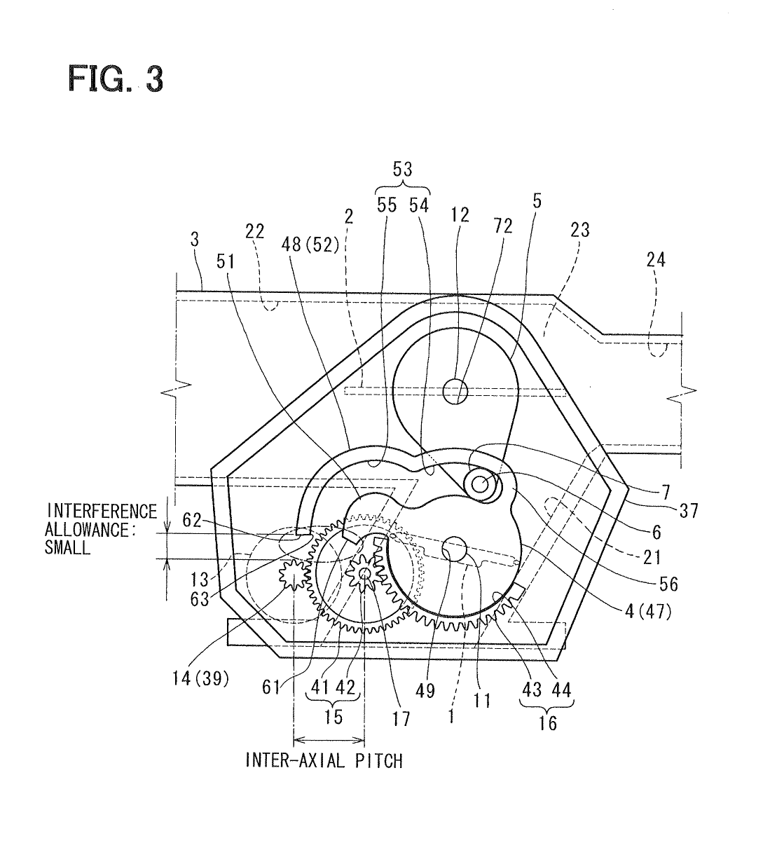

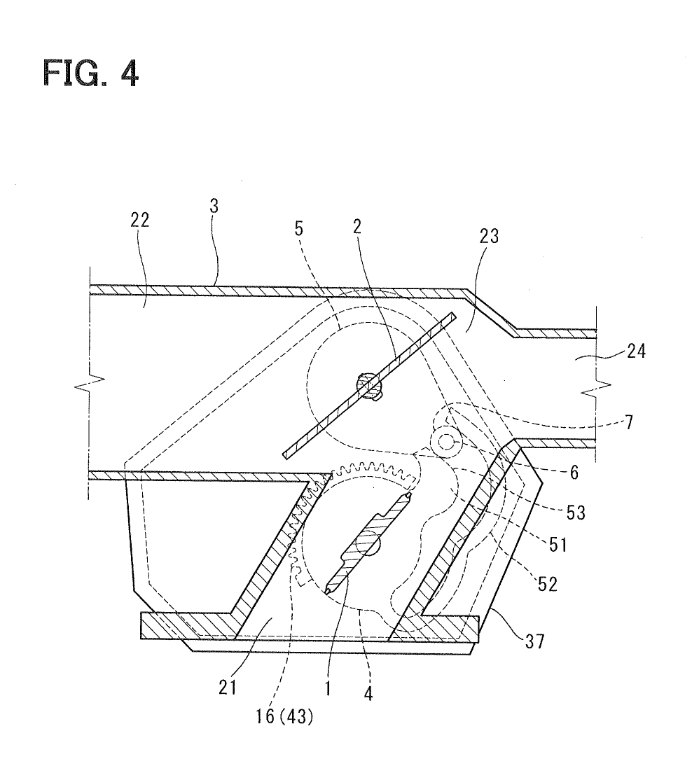

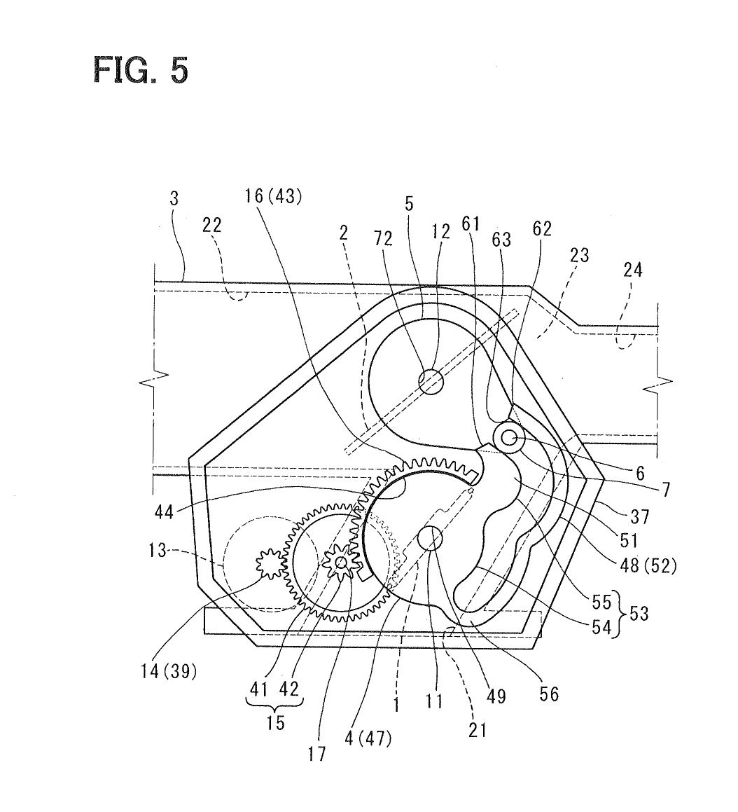

A configuration of an exhaust gas recirculation system in accordance with a first embodiment of the invention will be described. FIGS. 1 to 5 illustrate the first embodiment of the invention. FIG. 1 is a diagram illustrating a valve module of the exhaust gas recirculation system (low-pressure loop EGR system). FIGS. 2 and 3 are diagrams illustrating a state in which a low-pressure EGR control valve is fully closed and an intake throttle valve is fully opened. FIGS. 4 and 5 are diagrams illustrating a state in which the low-pressure EGR control valve is fully opened and the intake throttle valve is fully closed.

A control system for an internal combustion engine of the present embodiment (engine control system) includes the exhaust gas recirculation system (EGR system) that recirculates (returns) EGR gas, which is a part of exhaust gas of the internal combustion engine (engine) having cylinders, into a combustion chamber for each cylinder. A direct-injection type diesel engine, in which fuel is injected and supplied directly into the combustion chamber, is employed for the engine. An intake port and exhaust port communicate respectively with the combustion chamber for each cylinder of the engine. An intake manifold and exhaust manifold are connected to each cylinder of the engine. An injector, which injects and supplies fuel into the combustion chamber, is provided for each cylinder of the engine.

An air cleaner, an intake throttle valve, a compressor of a turbocharger, an inter cooler, and a throttle valve are disposed in an intake pipe connected to the intake manifold. An intake passage communicating with the intake port of the engine is formed inside the intake manifold and the intake pipe. A turbine of the turbocharger and an exhaust gas purifier are disposed in an exhaust pipe connected to the exhaust manifold. An exhaust passage communicating with the exhaust port of the engine is formed inside the exhaust manifold and the exhaust pipe.

The exhaust passage on an upstream side of the turbine and the intake passage on a downstream side of the inter cooler are connected together by an EGR gas pipe. An EGR gas passage for recirculating (returning) EGR gas, which is a part of exhaust gas of the engine, from the exhaust passage to the intake passage, is formed inside this EGR gas pipe. An EGR gas flow rate control valve (hereinafter referred to as a high-pressure EGR control valve) for controlling a flow rate of EGR gas, which flows through the EGR gas passage, by its opening and closing operation, is disposed in the EGR gas pipe. As described above, the exhaust gas recirculation system (EGR system) configured such that the take-out port, from which EGR gas is taken out, is located on an upstream side of the turbine of the turbocharger, is referred to as a “high-pressure loop (HPL) EGR system”.

The exhaust passage on a downstream side of the turbine or exhaust gas purifier and the intake passage on an upstream side of the compressor are connected together by the EGR gas pipe. The EGR gas passage for recirculating (returning) EGR gas from the exhaust passage to the intake passage, is formed inside this EGR gas pipe. An EGR gas flow rate control valve (hereinafter referred to as a low-pressure EGR control valve) for controlling a flow rate of EGR gas, which flows through the EGR gas passage, by its opening and closing operation, is disposed in the EGR gas pipe. As described above, the exhaust gas recirculation system (EGR system) configured such that the EGR gas take-out port is located on a downstream side of the turbine of the turbocharger, is referred to as a “low-pressure loop (LPL) EGR system”.

The engine control system of the present embodiment includes the EGR system having both the high-pressure loop EGR system and low-pressure loop EGR system, and an engine control unit (electronic control unit: hereinafter referred to as ECU) which controls this EGR system. This engine control system is used as an exhaust control system for the engine that controls exhaust gas discharged from the combustion chamber for each cylinder of the engine. A valve module is incorporated into the low-pressure loop EGR system along the intake pipe, i.e., at a connecting portion of the intake pipe to the EGR gas pipe. This valve module is an EGR valve module in which a first valve 1 that is a valving element of a first control valve (exhaust gas control valve), and a second valve 2 that is a valving element of a second control valve (intake throttle valve), are disposed in a single valve housing 3.

The valve module used for the low-pressure loop EGR system includes a valve housing (intake duct) 3, in which two first and second valves 1, 2 and an electric actuator are disposed; a plate-like cam member (hereinafter referred to as a cam plate) 4 that receives driving force of the electric actuator thereby to rotate; a plate-like link member (link arm: hereinafter referred to as a linking lever) 5 that receives the driving force of the electric actuator from this cam plate 4 thereby to rotate; a columnar pivot pin 6 fixed to this linking lever 5; and a cylindrical cam follower (hereinafter referred to as a roller) 7 that is supported rotatably by this pivot pin 6.

The electric actuator includes an electric motor 13 which generates driving force (torque) for rotating respective shafts (rotatable shafts 11, 12) of the two first and second valves 1, 2; a power transmission mechanism (deceleration mechanism constituted of three reduction gears 14 to 16) which transmits the rotation of this electric motor 13 to the cam plate 4; a coil spring 18 that urges the first valve 1 in its valve closing direction; and a coil spring 19 that urges the second valve 2 in its valve opening direction. Two first and second introduction passages 21, 22, a merging part 23, and one communication passage 24 are formed in the valve housing 3. A cylindrical first shaft bearing holding portion (bearing holder) 25 having a first shaft bearing hole therein, and a cylindrical second shaft bearing holding portion (bearing holder) 26 having a second shaft bearing hole therein are integrally provided for this valve housing 3.

The low-pressure EGR control valve that controls a flow rate of EGR gas, which flows through the first introduction passage 21, by its opening and closing operation is disposed inside the valve housing 3. This low-pressure EGR control valve includes the first valve 1 which opens and closes the first introduction passage 21, and the rotatable shaft 11 which is coupled with this first valve 1 in synchronization. The first valve 1 is formed from refractory metal such as heat resisting aluminum alloy or heat resisting steel. This first valve 1 is a circular disk-like first valve body accommodated rotatably in the first introduction passage 21. The first valve 1 has a function of variably controlling an EGR rate, which is a ratio of the EGR gas amount to a total flow of intake air supplied into the combustion chamber for each cylinder of the engine as a result of the first valve 1 being rotated (opened or closed) in an operationable range from its fully closed position to fully open position. The first valve 1 is welded and fixed to a valve holding portion of the rotatable shaft 11.

A seal ring groove 28 having an annular shape that holds a seal ring 27 is formed on a peripheral end face of the first valve 1 continuously in a circumferential direction of the valve 1. The seal ring 27 is formed from refractory metal in an annular or C-shaped manner. The seal ring 27 is fitted and held in the seal ring groove 28 such that an inner circumferential side part of the ring 27 can move in the seal ring groove 28 in a radial direction, axial direction, and circumferential direction of the valve 1 with an outer circumferential side part of the ring 27 projecting radially outward of the peripheral end face of the first valve 1. The seal ring 27 is in sliding contact with an inner peripheral surface of a cylindrical nozzle 29, which is fitted in a nozzle fitted part of the valve housing 3. The rotatable shaft 11 of the first valve 1 is formed from refractory metal, similar to the first valve 1. This rotatable shaft 11 is a first shaft that supports and fixes the first valve 1. The rotatable shaft 11 is held rotatably by the first shaft bearing hole of the valve housing 3 through a first shaft bearing member (an oil seal 31, a bush 32, a bearing 33 and so forth). An axis line of this rotatable shaft 11 serves as a rotation center of the first valve 1, and also functions as a rotation center of the cam plate 4.

The intake throttle valve that controls a flow rate of intake air, which flows through the second introduction passage 22, by its opening and closing operation is provided inside the valve housing 3. This intake throttle valve includes the second valve 2 which opens and closes the second introduction passage 22, and the rotatable shaft 12 which is coupled with this second valve 2 in synchronization. The second valve 2 is formed from refractory metal similar to the first valve 1 or heat-resistant synthetic resin. This second valve 2 is a circular disk-like second valve body accommodated rotatably in the second introduction passage 22 and the merging part 23. The second valve 2 has a function of generating a predetermined negative pressure in the merging part 23 by being rotated (opened or closed) in an operationable range from its fully open position to fully closed position. The second valve 2 is fastened to a valve holding portion of the rotatable shaft 12 via a fastening screw with the valve 2 inserted into a valve insertion hole formed at the valve holding portion of the rotatable shaft 12.

The rotatable shaft 12 of the second valve 2 is formed from refractory metal similar to the second valve 2 or heat-resistant synthetic resin. This rotatable shaft 12 is held rotatably by the second shaft bearing hole of the valve housing 3 through a second shaft bearing member (an oil seal 34, a bush 35, a bearing 36 and so forth). An axis line of the rotatable shaft 12 serves as a rotation center of the second valve 2, and also functions as a rotation center of the linking lever 5.

The valve housing 3 is formed from refractory metal such as heat resisting aluminum alloy or heat resisting steel. This valve housing 3 includes the first introduction passage 21 in which EGR gas flows; the second introduction passage 22 in which intake air flows; and the merging part 23 at which the two first and second introduction passages 21, 22 merges with the one communication passage 24. The first introduction passage 21 is an EGR gas introduction passage (first passage), in which EGR gas flows. This first introduction passage 21 communicates with the exhaust passage on a downstream side of the turbine of the turbocharger or the exhaust gas purifier through the EGR gas passage formed in the EGR gas pipe. An EGR gas (exhaust gas) introduction port (first port) for introducing EGR gas from the EGR gas pipe into the valve housing 3 is formed at an upstream end of the valve housing 3, i.e., at an upstream end of the first introduction passage 21 in the exhaust gas flow direction.

The second introduction passage 22 is an intake air introduction passage (second passage), in which intake air flows. This second introduction passage 22 communicates with the air cleaner through the intake passage formed inside the intake pipe on the air cleaner side. An intake air introduction port (second port) for introducing intake air from the intake pipe on the air cleaner side into the valve housing 3 is formed at the upstream end of the valve housing 3, i.e., at the upstream end of the second introduction passage 22 in the intake air flow direction. The communication passage 24 is a mixed gas guiding passage (third passage) in which the mixed gas of intake air and EGR gas or the intake air flows. This communication passage 24 communicates with the compressor of the turbocharger through the intake passage formed in the intake pipe on the engine side. A mixed gas guiding port (third port) for guiding out the mixed gas or intake air from the valve housing 3 into the intake pipe on the engine side is formed at a downstream end of the valve housing 3, i.e., at a downstream end of the communication passage 24 in the intake air flow direction.

The first shaft bearing holding portion 25 is provided to surround the oil seal 31, the bush 32, and the bearing 33 in their circumferential direction. The first shaft bearing hole extending in the direction of the rotatable shaft of the low-pressure EGR control valve is formed inside this first shaft bearing holding portion 25. The second shaft bearing holding portion 26 is provided to surround the oil seal 34, the bush 35, and the bearing 36 in their circumferential direction. The second shaft bearing hole extending in the direction of the rotatable shaft of the intake throttle valve is formed inside this second shaft bearing holding portion 26.

The electric actuator is a valve drive unit that drives the respective rotatable shafts 11, 12 of the two first and second valves 1, 2 via the cam plate 4 and the linking lever 5, and the electric actuator performs opening and closing control upon the two first and second valves 1, 2. The electric actuator includes the electric motor 13 which is a power source, a deceleration mechanism that decelerates the rotation of this electric motor 13 through two stages, and the coil springs 18, 19 that urge the two first and second valves 1, 2 in the valve closing direction and valve opening direction, respectively as illustrated in FIGS. 3 and 5.

An actuator case of the electric actuator is constituted of a motor housing 37 that accommodates the electric motor 13 and the deceleration mechanism, and a cover (cover body) 38 that closes an opening of this motor housing 37. The motor housing 37 is attached integrally on an outer wall surface of the valve housing 3. Or, the housing 37 is formed integrally on an outer wall part of the valve housing 3. The electric motor 13 generates torque when supplied with electric power. This electric motor 13 is accommodated and held in a motor accommodating space of the motor housing 37. The electric motor 13 is electrically connected to a battery disposed in a vehicle such as an automobile via a motor drive circuit which is electronically controlled by the ECU.

The deceleration mechanism is constituted of the three reduction gears 14 to 16, which are the components of the power transmission mechanism. This deceleration mechanism includes a pinion gear (motor gear) 14 which is fixed to a motor shaft (motor output shaft) of the electric motor 13, the intermediate gear 15 which is engaged with this pinion gear 14 thereby to rotate, and the final gear 16 which is engaged with this intermediate gear 15 thereby to rotate. The deceleration mechanism includes one support shaft (intermediate gear shaft) 17 that is arranged in parallel relative to the respective rotatable shafts 11, 12 of the two first and second valves 1, 2 and the motor shaft of the electric motor 13. The three reduction gears 14 to 16 are rotatably accommodated in a gear accommodating space of the motor housing 37.

The pinion gear 14 is press-fitted and fixed into the outer circumference of the motor shaft. Projecting gear teeth (pinion gear part) 39 that are engaged with the intermediate gear 15 are formed on the outer circumference of this pinion gear 14 entirely in a circumferential direction of the gear 14. The intermediate gear 15 is fitted rotatably around the outer circumference of the intermediate gear shaft 17. This intermediate gear 15 includes a cylindrical portion that is provided to surround the intermediate gear shaft 17 in the circumferential direction. A maximum external diameter part (larger diameter part) having an annular shape is formed integrally with the outer circumference of this cylindrical portion. Projecting gear teeth (major diameter gear part) 41, which are engaged with the projecting gear teeth 39 of the pinion gear 14, are formed on the outer circumference of the larger diameter part of the intermediate gear 15 entirely in a circumferential direction of the gear 15. Projecting gear teeth (minor diameter gear part) 42 which are engaged with the final gear 16 are formed on the outer circumference of the cylindrical portion (smaller diameter part) entirely in the circumferential direction.

The final gear 16 is formed in fan-like fashion by a predetermined rotation angle. This final gear 16 includes projecting gear teeth (major diameter gear part having a fan-like shape) 43 which are engaged with the projecting gear teeth 42 of the intermediate gear 15. The final gear 16 includes an arc-shaped cam holding portion 44 which is fitted around the outer peripheral part of the cam plate 4. Therefore, the final gear 16 is provided integrally with the outer peripheral part of the cam plate 4. The intermediate gear shaft 17 is driven into a fitting hole of the motor housing 37, to be press-fitted and fixed in a fitted part of the motor housing 37. An axis line of this intermediate gear shaft 17 serves as a rotation center of the intermediate gear 15.

The coil spring 18 is wound in a spiral manner around a cylindrical portion 45 that is formed integrally with the outer circumference of the first shaft bearing holding portion (cylindrical portion) 25 of the valve housing 3 and the final gear 16 (or cam plate 4). The coil spring 19 is wound in a spiral manner around a cylindrical portion 46 that is formed integrally with the outer circumference of the second shaft bearing holding portion (cylindrical portion) 26 of the valve housing 3 and the linking lever 5.

The cam plate 4 is formed into a predetermined shape from metal or synthetic resin. The plate 4 is disposed to be exposed to the outside of the valve housing 3, and rotatably accommodated in the gear accommodating space of the motor housing 37, similar to the deceleration mechanism. This cam plate 4 is configured to rotate with the rotatable shaft 11 being its center on receiving the driving force of the electric actuator. The cam plate 4 includes the above-described final gear 16, a cam base 47 that is rotated together with the rotatable shaft 11 of the first valve 1 on receiving motor torque from this final gear 16, and a cam frame 48 which transmits the motor torque to the linking lever 5.

An input part which receives the motor torque from the final gear 16, and a first output part (first driving unit) that rotates the rotatable shaft 11 of the first valve 1 in synchronization with the rotation of the cam plate 4 are provided for the cam base 47 of the cam plate 4. The input part of the cam base 47 is fixed integrally to the cam holding portion 44 of the final gear 16. Or, the cam plate 4 is formed integrally with the inner circumferential portion of the final gear 16. A fitting hole 49, into which the rotatable shaft 11 of the first valve 1 is fitted, is formed in the first output part of the cam base 47. Accordingly, the rotatable shaft 11 of the first valve 1 is coupled with the first output part of the cam plate 4 in an integrally rotatable manner.

A second output part (second driving unit) that rotates the rotatable shaft 12 of the second valve 2 in synchronization with the rotation of the cam plate 4 is provided for the cam frame 48 of the cam plate 4. Cam projection pieces 51, 52 are formed at this second output part. The second output part of the cam frame 48 includes a cam groove 53 that drives the linking lever 5 in synchronization with the rotation of the cam plate 4. The cam projection pieces 51, 52 extend radially outward of the cam base 47 and curving in a formation direction of the cam groove 53. The cam projection piece 51 projects from the outer peripheral part into the outside of the cam base 47. The cam projection piece 52 extends from the outer peripheral part of the cam base 47 toward the second-valve fully-closed side in the formation direction of the cam groove 53.

The cam groove 53 is formed inside the cam frame 48, between the cam base 47 and the cam projection piece 52, and between the cam projection pieces 51, 52. This cam groove 53 is a guide groove that guides the pivot pin 6 and the roller 7 in the formation direction of the cam groove 53 to rotate the linking lever 5 in synchronization with the rotation of the cam plate 4. The cam groove 53 is formed so as to rotate the rotatable shaft 12 of the second valve 2 in an operation pattern different from the first valve 1 in accordance with the rotation of the cam plate 4 by means of the combination of more than one (two) circular arc grooves 54, 55 having different curvature radiuses and curvature centers from one another. A cam profile having a shape corresponding to the operation pattern of the second valve 2, which is different from the first valve 1, is formed on both side surfaces of this cam groove 53 in its groove width direction. The circular arc groove 54 of the cam groove 53 has a predetermined curvature radius with the rotation center of the cam plate 4 being the center of curvature. The circular arc groove 55 of the cam groove 53 has the region that is different from the rotation center of the cam plate 4 as its center of curvature, and the groove 55 has a curvature radius smaller than the circular arc groove 54.

The circular arc groove 54 indicates a non-synchronization section (non-synchronization section in the cam groove 53) in which the two first and second valves 1, 2 are not synchronized with each other by fixing the second valve 2 at its fully open position irrespective of the opening/closing state of the first valve 1 while the rotation angle of the cam plate 4 changes from the minimum value (e.g., 0 degrees) to the intermediate value (e.g., 50 degrees). A groove side face of the circular arc groove 54 is formed on an outer lateral surface of the cam base 47. The circular arc groove 55 indicates a synchronization section (synchronization section in the cam groove 53), in which the two first and second valves 1, 2 are synchronized with each other so as to close the second valve 2 in accordance with the valve opening action of the first valve 1 during the change of the rotation angle of the cam plate 4 from the intermediate value (e.g., 50 degrees) to the maximum value (e.g., 90 degrees). A groove side face of the circular arc groove 55 is formed on an outer lateral surface of the cam projection piece 51. Groove side faces of the circular arc grooves 54, 55 are formed on an inner lateral surface of the cam projection piece 52.

A joining section 56 that couples together the cam base 47 and the cam projection piece 52 in a semicircular manner to limit further displacement of the pivot pin 6 and the roller 7 toward the second-valve fully-open side is formed at the second-valve fully-open side (other end side) end of the cam groove 53 in the formation direction of the circular arc groove 54. Open end parts (open end parts of the cam projection pieces 51, 52 of the cam plate 4) 61, 62 that open into the outside of the cam plate 4 are formed at the second-valve fully-closed side (one end side) end of the cam groove 53 in the formation direction of the circular arc groove 55. A cam groove opening 63 that opens on the end faces of the cam plate 4 (open end parts 61, 62) is provided for the cam projection pieces 51, 52 of the cam plate 4.

The open end parts 61, 62 and the cam groove opening 63 of the cam projection pieces 51, 52 of the cam plate 4 are formed through the elimination (removal) of the portion that is unnecessary for the opening and closing operation of the second valve 2 from an overlapping part of the cam projection pieces 51, 52 that overlaps with the electric actuator (particularly the intermediate gear 15). A distance from a limit position of a moving range of the roller 7 on its one side (fully closed position of the second valve 2) along the cam groove 53 of the cam plate 4 to the end faces of the open end parts 61, 62 (cam groove opening 63) is set in view of such an allowance as to avoid the separation of the roller 7 from the cam groove 53. More specifically, the size of the cam groove 53 in its formation direction is obtained as a result of the addition of the allowance to the entire moving range of the roller 7 (axis line distance of the circular arc grooves 54, 55 from the fully closed position of the first valve 1 as well as the fully open position of the second valve 2 to the fully open position of the first valve 1 as well as the fully closed position of the second valve 2).

The linking lever 5 is formed into a predetermined shape from metal or synthetic resin, and is disposed to be exposed to the outside of the valve housing 3. Furthermore, the linking lever 5 is rotatably accommodated in the gear accommodating space of the motor housing 37, similar to the deceleration mechanism. An input part that receives the torque of the electric motor 13 of the electric actuator from the cam plate 4 is provided for the one end part of the linking lever 5. An output part that rotates the rotatable shaft 12 of the second valve 2 in synchronization with the rotation of the cam plate 4 is provided at the rotation center part of the linking lever 5. A fitting hole 71, into which the pivot pin 6 is fitted, is formed at the input part of the linking lever 5. A fitting hole 72, into which the rotatable shaft 12 is fitted, is formed at the output part of the linking lever 5. Accordingly, the rotatable shaft 12 of the second valve 2 is coupled with the output part of the linking lever 5 in an integrally rotatable manner.

The pivot pin 6 and the roller 7 are inserted (engaged) movably in the circular arc grooves 54, 55 of the cam groove 53 of the cam plate 4. These pivot pin 6 and the roller 7 are guided in the formation direction of the cam groove 53 along a groove side face (cam profile) of the circular arc grooves 54, 55. The pivot pin 6 is formed into a predetermined shape from metal, and driven into the fitting hole 71 of the linking lever 5 to be press-fitted and fixed to the input part of the linking lever 5. The axis line of this pivot pin 6 serves as the rotation center of the roller 7. The roller 7 is formed into a cylindrical shape from metal, and fitted rotatably around the outer circumference of the pivot pin 6. This roller 7 includes a cylindrical portion to surround the pivot pin 6 in the circumferential direction.

Operation of the first embodiment will be described below. Workings of the valve module that is incorporated into the low-pressure loop EGR system of the present embodiment will be briefly described in reference to FIGS. 1 to 5.

The electric motor 13 of the electric actuator of the present embodiment is configured to be energization-controlled by the ECU. When electric power is not supplied to the electric motor 13, an opening degree of the first valve 1 is set to be at a fully closed position to fully close the first introduction passage 21 by urging force (spring force) of the coil spring 18. Thus, the first valve 1 is put in a fully closed state so that the first introduction passage 21 is closed. Meanwhile, an opening degree of the second valve 2 is set to be at a fully open position to fully open the second introduction passage 22 and the merging part 23 by urging force (spring force) of the coil spring 19. Thus, the second valve 2 is in a fully open state so that the second introduction passage 22 and the merging part 23 are opened. Accordingly, the EGR gas is not mixed into fresh air (clean intake air filtered through the air cleaner).

In the case of the valve opening operation of the first valve 1 within a range from the fully closed opening degree to intermediate opening degree, the electric power supply to the electric motor 13 of the electric actuator is controlled such that the rotation angle of the cam plate 4 reaches a predetermined value that is within a range from the minimum value (e.g., 0 degrees) to an intermediate value (e.g., 50 degrees), to perform the opening and closing control of the first valve 1 in accordance with an operation condition (operational state) of the engine and to maintain the fully open state of the second valve 2. Accordingly, the motor shaft of the electric motor 13 is rotated in a fully-open direction. As a result, the torque (motor torque) of the electric motor 13 is transmitted to the pinion gear 14, the intermediate gear 15, and the final gear 16. Then, the cam plate 4, to which the motor torque is transmitted from the final gear 16, rotates in the valve opening direction by a predetermined rotation angle (rotation angle that is the same as the operating angle of the final gear 16) in accordance with the rotation of the final gear 16.

Meanwhile, despite the rotation of the cam plate 4 around the rotatable shaft 11 by the predetermined rotation angle, since the circular arc groove 54 of the cam groove 53 of the cam plate 4 has a curvature radius with the rotatable shaft 11 being its center of curvature, the motor torque is not transmitted from the groove side face of the circular arc groove 54 to the pivot pin 6, which is fixed to the input part of the linking lever 5, and the roller 7, and the positions of the pivot pin 6 and the roller 7 do not change. Accordingly, even though the cam plate 4 rotates and the pivot pin 6 and the roller 7 are displaced from the first valve fully closed position to first valve intermediate position of the cam groove 53, the linking lever 5 does not rotate around the rotatable shaft 12. Therefore, the degree of opening of the second valve 2 does not change. As a result, the rotation angle of the cam plate 4 is changed to the predetermined value (predetermined rotation angle) within the range from the minimum value to the intermediate value, and the rotation angle of the linking lever 5 is stopped at an angle, at which the fully open state of the second valve 2 is maintained. Consequently, the first valve 1 is opened by an opening degree that is in accordance with the engine operation condition, and the second valve 2 continues its fully open state. Therefore, the two first and second introduction passages 21, 22 are opened.

Thus, the EGR gas, which is taken into the EGR gas passage from the exhaust passage on the downstream side of the turbine of the turbocharger or the exhaust gas purifier, flows in through an EGR gas introduction port of the valve housing 3. This EGR gas is then introduced into the merging part 23 of the valve housing 3 through the first introduction passage 21 of the valve housing 3. The intake air, which is filtered through the air cleaner, flows in through an intake air introduction port of the valve housing 3. This intake air is then introduced into the merging part 23 of the valve housing 3 through the second introduction passage 22 of the valve housing 3. After that, the EGR gas and intake air are mixed together to become the mixed gas in the merging part 23 and the communication passage 24. The mixed gas flows into the intake port for each cylinder of the engine through the intake passage formed inside the intake pipe on the engine side and the intake manifold. The mixed gas is then introduced into the combustion chamber for each cylinder of the engine from each intake port. As a consequence, harmful substances (e.g., NOx) contained in the exhaust gas from the engine can be reduced.

In the case of valve opening operation of the first valve 1 within the range from the intermediate opening degree to fully open opening degree, the electric power supply to the electric motor 13 of the electric actuator is controlled such that the rotation angle of the cam plate 4 reaches a predetermined value within the range from the intermediate value to the maximum value (e.g., 90 degrees) to perform the opening and closing control of the two first and second valves 1, 2 in accordance with the engine operation condition. Accordingly, the motor shaft of the electric motor 13 is rotated further in the fully-open direction. As a result, the motor torque is transmitted to the pinion gear 14, the intermediate gear 15, and the final gear 16. Then, the cam plate 4, to which the motor torque is transmitted from the final gear 16, rotates further in the valve opening direction by a predetermined rotation angle in accordance with the rotation of the final gear 16.

As a result, the pivot pin 6 of the linking lever 5 and the roller 7 enter from the circular arc groove 54 to the circular arc groove 55 of the cam groove 53 of the cam plate 4. Then, the pivot pin 6 and the roller 7 moves along the groove side face of the circular arc groove 55 of the cam groove 53, rolling thereon (being engaged therewith) in the range from the first valve intermediate position to first valve fully open position of the cam groove 53. In consequence, the motor torque is transmitted from the groove side face of the circular arc groove 55 of the cam groove 53 of the cam plate 4 to the pivot pin 6 of the linking lever 5 and the roller 7, and the linking lever 5 thereby rotates in the valve closing direction around the rotatable shaft 12. Accordingly, inversely with the rotation of the first valve 1 in the fully open direction around the rotatable shaft 11 in accordance with the rotation of the cam plate 4 and the rotatable shaft 11, the second valve 2 rotates around the rotatable shaft 12 in the valve closing direction in accordance with the rotation of the rotatable shaft 12.

Thus, the rotation angle of the cam plate 4 is changed to a predetermined value (predetermined rotation angle) within the range from the intermediate value to the maximum value; and the rotation angle of the linking lever 5 is changed to a predetermined value (predetermined rotation angle) within the range from the second valve fully open position to second valve fully closed position. Accordingly, the first valve 1 is opened by the opening degree that is in accordance with the engine operation condition; and the second valve 2 is closed by the degree of opening corresponding to the engine operation condition. As a result, the first introduction passage 21 is opened and a passage sectional area of the second introduction passage 22 is reduced. Therefore, in the operating range in which the large amount of EGR gas is recirculated by means of the low-pressure loop EGR system, the first valve 1 is opened and the second valve 2 is closed to increase a differential pressure between the exhaust passage side and intake passage side. Thus, using the low-pressure loop EGR system, the large amount of EGR gas can be returned into the intake port and combustion chamber for each cylinder of the engine.

Characteristics of the first embodiment will be described below. As described above, in order to prevent the interference between the cam plate 4 having the cam groove 53 that decreases the size of (downsizes) the cam plate 4 and that guides the roller 7 held by the pivot pin 6 fixed to the linking lever 5, and the electric actuator (particularly the intermediate gear 15) having the electric motor 13 and the deceleration mechanism (three reduction gears 14 to 16), the valve module used for the low-pressure loop EGR system of the present embodiment includes the first valve 1, which is the valving element of the low-pressure EGR control valve; the second valve 2, which is a valving element of the intake throttle valve; the valve housing 3 in which the two first and second valves 1, 2 are disposed; the cam plate 4 that receives the motor torque from the final gear 16 to rotate together with the rotatable shaft 11 of the first valve 1; the linking lever 5 that receives the motor torque from this cam plate 4 to rotate together with the rotatable shaft 12 of the second valve 2; the pivot pin 6 that is inserted movably in the cam groove 53 of the cam plate 4; and the roller 7 supported by this pivot pin 6.

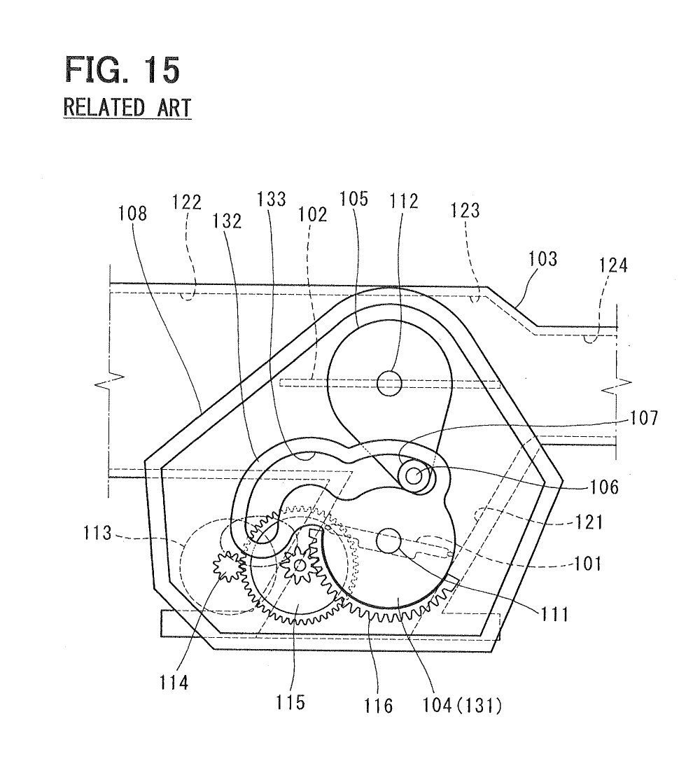

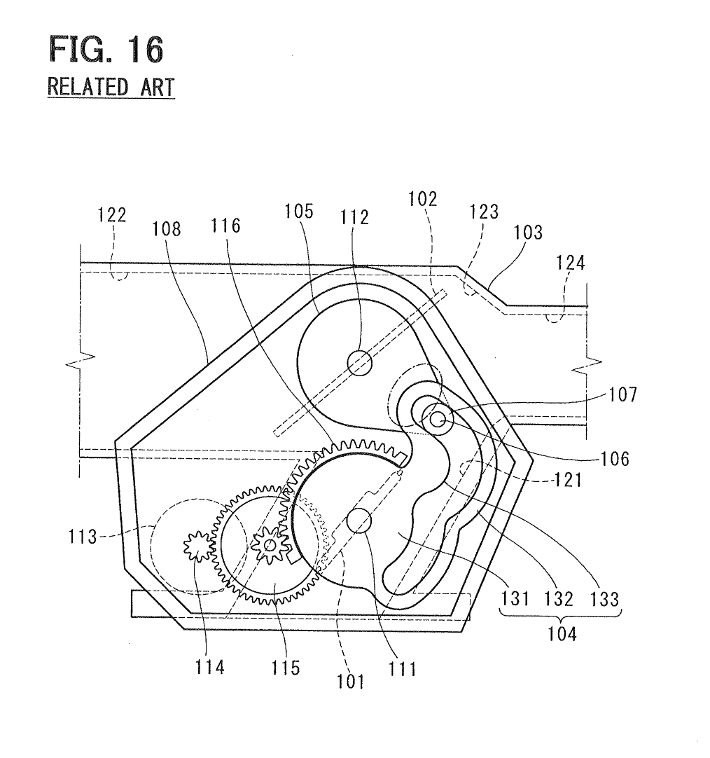

In the low-pressure loop EGR system (comparative example) illustrated in FIGS. 15 and 16, a valve unit configured to drive a first valve 101 of a low-pressure EGR control valve and a second valve 102 of an intake throttle valve by a single electric actuator is provided. In order to prevent the separation of a roller 107 supported by a pivot pin 106 of a linking lever 105 from a cam groove 133, a cam plate 104 has a shape that surrounds the whole circumference of the cam groove 133, and the size of the cam plate 104 is thereby increased. Accordingly, the entire valve unit is increased in size to ensure a space for disposing the cam plate 104, and a problem that the installability of the system in an engine compartment of a vehicle such as an automobile deteriorates is caused.

Accordingly, in order to decrease the size of (to downsize) the cam plate 4, through the elimination (removal) of the portion that is unnecessary for the opening and closing operation of the second valve 2 from the overlapping part of the cam projection pieces 51, 52 of the cam plate 4 that overlaps with the intermediate gear 15, at the open end parts 61, 62 and the cam groove opening 63 of the cam projection pieces 51, 52 of the cam plate 4, the size of the cam plate 4 (particularly, the sizes of the open end parts 61, 62 of the cam projection pieces 51, 52 formed on their one side in the formation direction of the cam groove 53) is reduced. As a result, the interference between the cam plate 4 and the intermediate gear 15 can be limited.

Therefore, in comparison with the low-pressure loop EGR system (comparative example), which is provided with the cam plate 104 having an overlapping portion with the electric actuator (particularly the final gear 116), and an unnecessary cam groove portion into which the roller 107 does not enter over the entire operating range of the second valve 102, the cam plate 4 can be reduced in size and the interference between the cam plate 4 and the intermediate gear 15 can be limited. Moreover, because the allowance for the interference between the cam plate 4 and the electric actuator can be improved without increasing a clearance between the cam plate 4 and the intermediate gear 15 in their rotation axis directions, the size of the entire valve module can be reduced. Thus, the installability of the valve module in the engine compartment of the vehicle such as an automobile can be improved.

### Second Embodiment

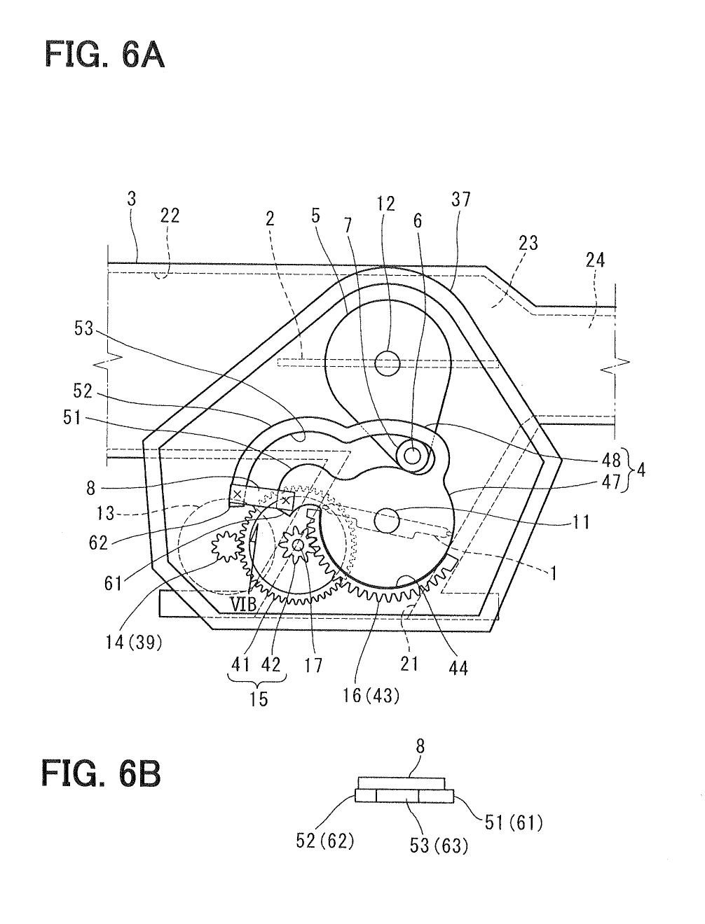

FIGS. 6A and 6B are diagrams illustrating operating states of a cam plate and a linking lever when a low-pressure EGR control valve is fully closed.

Similar to the first embodiment, a valve module used for a low-pressure loop EGR system in accordance with a second embodiment of the invention includes a first valve 1, which is a valving element of the low-pressure EGR control valve; a second valve 2, which is a valving element of an intake throttle valve; a valve housing 3 in which two first and second valves 1, 2 are disposed; a cam plate 4 which drives a rotatable shaft 11 of the first valve 1; a linking lever 5 which drives a rotatable shaft 12 of the second valve 2; and an electric actuator that opens and closes the two first and second valves 1, 2 through the cam plate 4, the linking lever 5, a roller 7 and so forth. An electric motor 13 of the electric actuator is configured to be energization-controlled by an ECU.

Open end parts 61, 62, which open into the outside of the cam plate 4, are formed on one end side of a cam groove 53 of the cam plate 4 in its formation direction. The free end side of a cam projection piece 52 of the cam plate 4 is not coupled with a cam base 47, and is a low-strength part having lower strength than the cam base 47 and a cam projection piece 51. In this case, since the strength of the cam projection piece 52 of the cam plate 4 is low, there are defects of deteriorated operational reliability and durability of the cam plate 4. Accordingly, for the purpose of solving the above defects, a reinforcing stay 8, which is a bridge-like reinforcement part that couples together the free end portions of the cam projection pieces 51, 52 of the cam plate 4 to connect the free end portion of the cam projection piece 52 to the cam projection piece 51 on the cam base 47-side, is provided.

The reinforcing stay 8 reinforces the cam projection pieces 51, 52 of the cam plate 4 through its bridge between the free end portions of the cam projection pieces 51, 52. This reinforcing stay 8 is disposed at such a position as not to interfere with a pivot pin 6 or the roller 7. As illustrated in FIGS. 6A and 6B, the method, whereby the reinforcing stay 8 which is separate from the cam plate 4, is made of metal, and this metal reinforcing stay 8 is welded and fixed to the free end portions of the cam projection pieces 51, 52 of the metal cam plate 4, is employed for a method for fixing the reinforcing stay 8 to the cam plate 4. Alternatively, the reinforcing stay 8 may be formed integrally with the cam plate 4, and level-difference press working may be performed on the reinforcing stay 8 such that the stay 8 is located outward of the cam groove 53 not to interfere with the pivot pin 6 or the roller 7.

As described above, the free end portions of the cam projection pieces 51, 52 are coupled with each other through the reinforcing stay 8, which is separate from the cam plate 4, to bridge a gap between the free end portions of the cam projection pieces 51, 52 of the metal cam plate 4 of the present embodiment. Accordingly, the cam projection piece 52, which is a low-strength part having lower strength than the cam base 47 and the cam projection piece 51, can be reinforced. Thus, mechanical strength of the entire cam plate 4 can be improved, and the operational reliability and durability of the cam plate 4 can be improved. Furthermore, since the reinforcing stay 8 is disposed at such a position as not to interfere with the pivot pin 6 or the roller 7, the interference between the pivot pin 6 or the roller 7, and the reinforcing stay 8 can reliably be prevented. As a result, the operational reliability of the cam plate 4 and the linking lever 5 can be improved.

### Third Embodiment

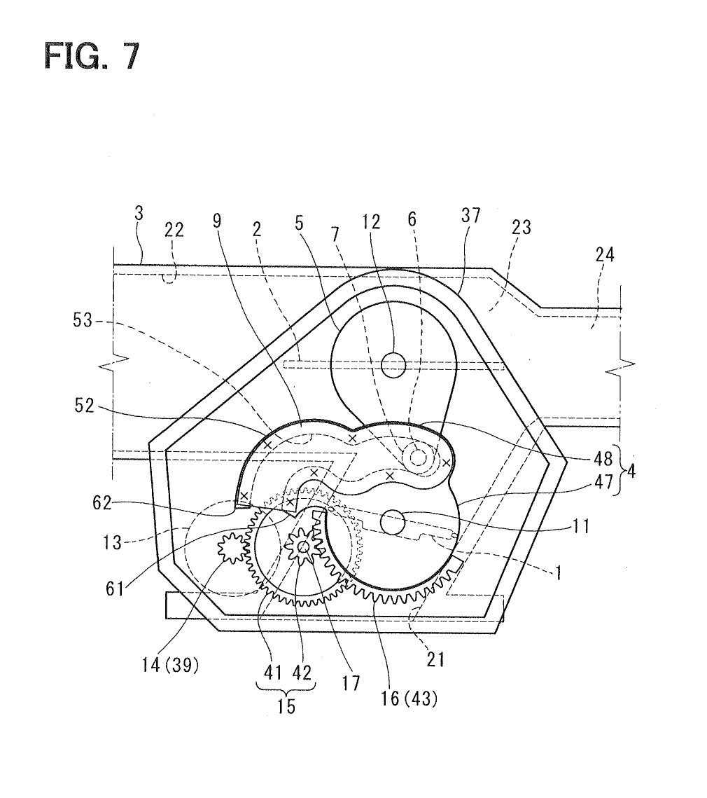

FIG. 7 is a diagram illustrating operating states of a cam plate and a linking lever when a low-pressure EGR control valve is fully closed.

Similar to the first and second embodiments, a valve module in accordance with a third embodiment of the invention includes a first valve 1, which is a valving element of the low-pressure EGR control valve; a second valve 2, which is a valving element of an intake throttle valve; a valve housing 3 in which two first and second valves 1, 2 are disposed; a cam plate 4 which drives a rotatable shaft 11 of the first valve 1; a linking lever 5 which drives a rotatable shaft 12 of the second valve 2; and an electric actuator that opens and closes the two first and second valves 1, 2 through the cam plate 4, the linking lever 5, a roller 7 and so forth. An electric motor 13 of the electric actuator is configured to be energization-controlled by an ECU.

In the cam plate 4 of the present embodiment, a reinforcing plate 9, which is a plate-like reinforcement part covering the entire groove surface of a cam groove 53, is added to the above-described second embodiment as further measures to reinforce a cam projection piece 52. The reinforcing plate 9 is disposed at such a position as not to interfere with a pivot pin 6 or the roller 7. Similar to the second embodiment, the method, whereby the reinforcing plate 9 which is separate from the cam plate 4, is made of metal, and this metal reinforcing plate 9 is welded and fixed to an outer peripheral part of a cam base 47 of the metal cam plate 4 and to the cam projection pieces 51, 52, is employed for a method for fixing the reinforcing plate 9 to the cam plate 4. Alternatively, the reinforcing plate 9 may be formed integrally with the cam plate 4, and level-difference press working may be performed on the reinforcing plate 9 such that the reinforcing plate 9 is located outward of the cam groove 53 not to interfere with the pivot pin 6 or the roller 7.

As above, by covering the entire groove surface of the cam groove 53 with the reinforcing plate 9 to bridge a gap between the cam projection pieces 51, 52 of the cam plate 4 of the present embodiment, the cam projection piece 52 which is a lower strength part than the cam base 47 and the cam projection piece 51, can be reinforced. Thus, mechanical strength of the entire cam plate 4 is improved, and further improvement in operational reliability and durability of the cam plate 4 can be expected. Furthermore, since the reinforcing plate 9 is disposed at such a position as not to interfere with the pivot pin 6 or the roller 7, the interference between the pivot pin 6 or the roller 7, and the reinforcing plate 9 can reliably be prevented. As a result, the operational reliability of the cam plate 4 and the linking lever 5 can be improved. In addition, a function as a dust entry prevention cover for preventing (limiting) the entering of dust (such as gear worn powder) into between the groove side face of the cam groove 53 of the cam plate 4 and the outer peripheral surface of the roller 7, can also be given to the reinforcing plate 9 covering the entire groove surface of the cam groove 53.

Modifications to the above embodiments will be described below. In the above embodiments, the exhaust gas recirculation system of the present invention is applied to the valve module (including the valve unit of the low-pressure EGR control valve and the intake throttle valve) of the low-pressure loop EGR system. Alternatively, the Exhaust gas recirculation system of the present invention may be applied to a valve module (including a valve unit of the high-pressure EGR control valve and the throttle valve) of the high-pressure loop EGR system. Moreover, not only a diesel engine but a gasoline engine may also be used for the internal combustion engine (e.g., an engine for traveling) disposed in the vehicle such as an automobile. In addition, not only a multi-cylinder engine but a single cylinder engine may also be employed as the internal combustion engine (engine).

In the above embodiments, the actuator (valve drive unit) that opens and closes the two first and second valves 1, 2 is configured by the electric actuator having the electric motor 13 and the deceleration mechanism. Alternatively, the actuator that opens and closes the two first and second valves 1, 2 may also be configured by a negative pressure-operated actuator having an electromagnetic or electric-powered negative pressure control valve, or an electromagnetic actuator provided with an electromagnet including a coil. In the above embodiments, the valve module is configured such that the exhaust gas (EGR gas) flows inside the first introduction passage (first passage) 21, and that the intake air flows inside the second introduction passage (second passage) 22. Alternatively, the valve module may be configured such that the intake air flows inside the first introduction passage (first passage) 21, and that the exhaust gas flows inside the second introduction passage (second passage) 22. In this case, the first valve that controls (the flow rate of) intake air flowing through the first passage by its opening and closing operation serves as the valving element of the intake throttle valve, and the second valve that controls (the flow rate of) exhaust gas flowing through the second passage by its opening and closing operation serves as the valving element of the low-pressure EGR control valve.

In the above embodiments, the overlapping part of the cam frame 48 (cam projection pieces 51, 52) of the cam plate 4 that overlaps that overlaps with the electric actuator (particularly the intermediate gear 15) is formed on the second-valve fully-closed side of the cam frame 48 of the cam plate 4. Accordingly, the open end parts 61, 62, which open into the outside of the cam plate 4, are provided at the second-valve fully-closed side end of the cam groove 53 in its formation direction. Alternatively, if an overlapping part of the cam frame 48 (cam projection pieces 51, 52) of the cam plate 4 that overlaps with the electric actuator is formed on the second-valve fully-open side of the cam frame 48 of the cam plate 4, open end parts, which open into the outside of the cam plate 4 may be formed at the second-valve fully-open side end of the cam groove 53 in its formation direction. Moreover, in order to reliably prevent the separation of the roller 7 from the cam groove 53 of the cam plate 4, a stopper for restricting the rotation movement of the cam plate 4 or the final gear 16 on the second-valve fully-closed side (or the second-valve fully-open side) may be provided for the motor housing 37 or the cover 38.

Japanese patent application No. 2010-274687 (filing date: Dec., 9, 2010) has already been filed in order to reduce the size of the cam plate. A valve unit in this application is illustrated in FIG. 3. A first valve 1 is a valving element of an EGR control valve, and a second valve 2 is a valving element of an intake throttle valve.

This valve unit includes two first and second valves 1, 2, a valve housing 3, a cam plate, a linking lever 5, a pivot pin 6, a roller 7, an electric actuator, and a motor housing. The electric actuator includes a motor 13 which generates driving force for driving respective rotatable shafts 11, 12 of the two first and second valves 1, 2, and a deceleration mechanism (three gears 14 to 16) that decelerates the rotation of this motor 13 through two stages. The gear 16 is fixed to an outer peripheral part of the cam plate. An EGR gas introduction passage 21, an intake air introduction passage 22, a merging part 23, and a communication passage 24 are formed in the valve housing 3.

The cam plate includes a cam base 47 that receives motor torque from the final gear 16 to be rotated together with the rotatable shaft 11 of the first valve 1, a cam frame 48 which transmits the motor torque to the linking lever 5, and a cam groove 53 along which the linking lever 5 is driven. This cam groove 53 is formed inside the cam frame 48, i.e., between cam projection pieces 52, 51. The linking lever 5 receives the motor torque from the cam frame 48 to rotate together with the rotatable shaft 12 of the second valve 2. The pivot pin 6 is fixed to the linking lever 5. The roller 7 is supported rotatably by the pivot pin 6 and guided along the cam groove 53 of the cam frame 48.

The above-described valve unit has, unlike JP-A-2010-190116, a shape of the cam plate that eliminates an end portion of the cam frame 48, which does not influence the separation of the roller 7 from the cam groove 53 of the cam plate and which constitutes the cam groove 53, i.e., open end parts (free end portions) of the cam projection pieces 52, 51. In this manner, through the elimination of the open end parts of the cam projection pieces 52, 51 of the cam frame 48, the cam plate can be decreased in size compared to the system described in JP-A-2010-190116. As a result of the downsizing of the cam plate, an allowance for interference between the cam plate and the electric actuator is increased. Thus, the entire product can be decreased in size.

However, in the valve unit, the end portion of the cam frame 48 of the cam plate may interfere with the motor gear 14 fixed to the shaft of the motor 13, and an inter-axial pitch between the rotatable shaft of the motor gear 14 and a rotatable shaft of an intermediate gear 15 cannot be reduced. As a result, the size of the entire system needs to be made even larger in order to increase the allowance for the interference between the cam plate and the motor gear 14. Therefore, in accordance with the grow in size of the entire system, further deterioration of the installability of the valve unit can be caused.

Fourth and fifth embodiments of the invention will be described in detail below in reference to the accompanying drawings. The invention achieves (configures) the purpose of decreasing a cam member in size through the reduction of an inter-axial pitch between a motor gear axis and an intermediate gear axis; preventing reliably the interference between the cam member and a motor gear; and downsizing the entire system through the elimination (removal) of at least a portion unnecessary for the operation of a second valve from an overlapping part of a cam frame having a cam groove therein that overlaps with a motor and the motor gear.

### Fourth Embodiment

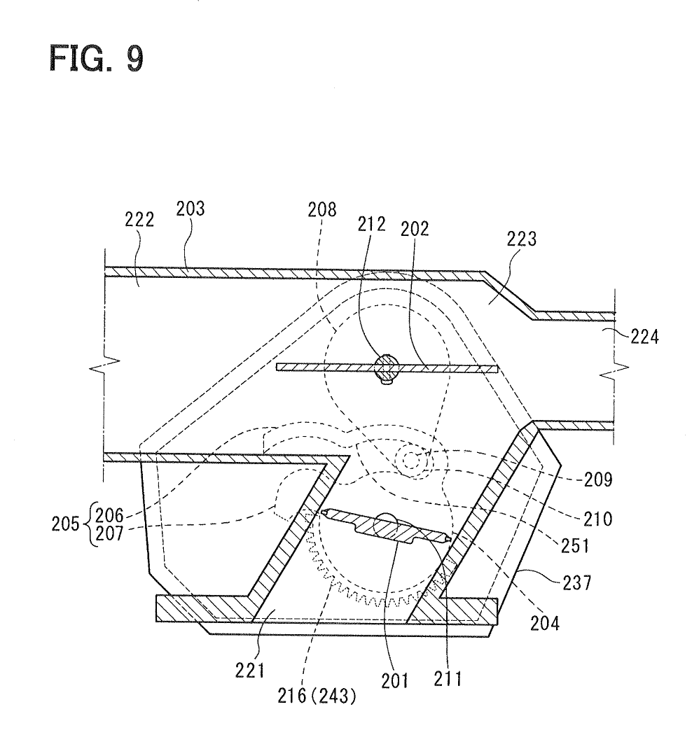

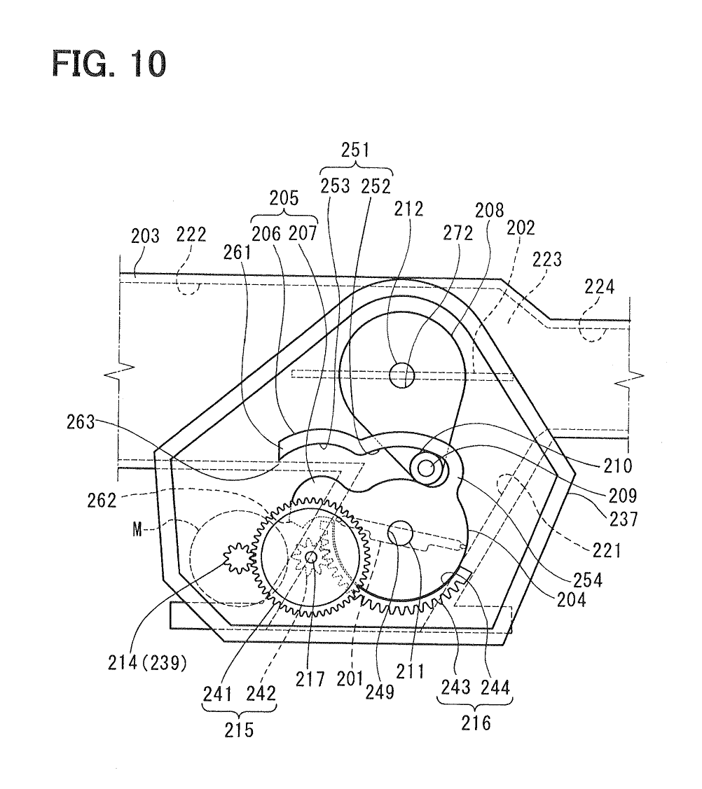

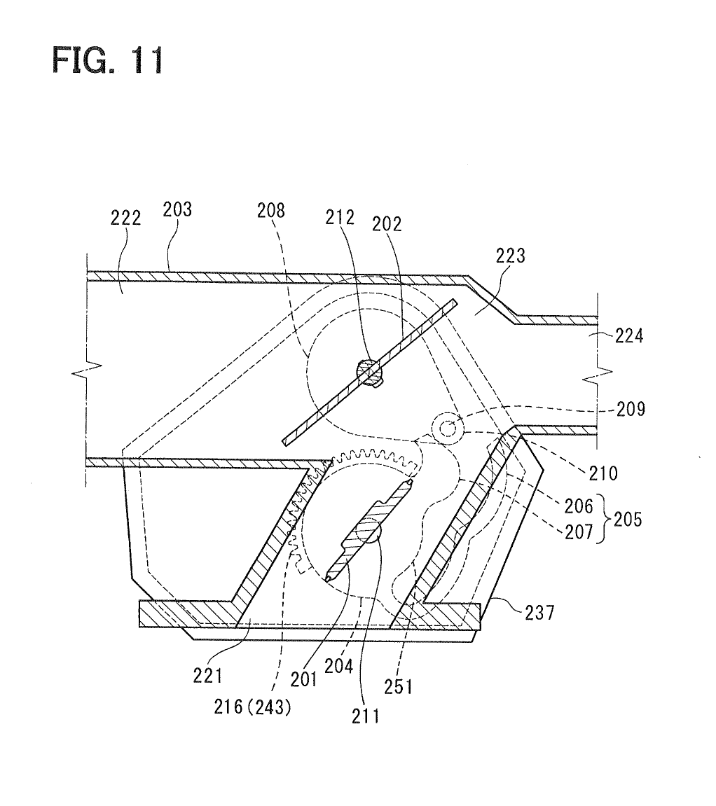

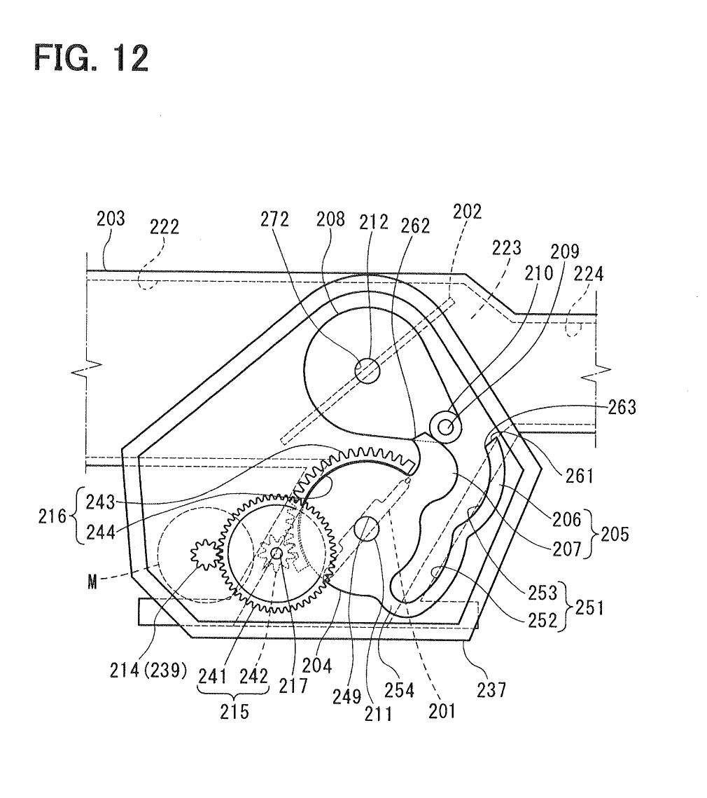

Configuration of a fourth embodiment of the invention will be described below. FIGS. 9 and 10 are diagrams illustrating a state in which a low-pressure EGR control valve is fully closed and an intake throttle valve is fully open. FIGS. 11 and 12 are diagrams illustrating a state in which the low-pressure EGR control valve is fully open and the intake throttle valve is fully closed.

A control system for an internal combustion engine of the present embodiment (engine control system) includes the exhaust gas recirculation system (exhaust system for the engine, EGR system) that recirculates (returns) EGR gas, which is a part of exhaust gas of the internal combustion engine (engine) having cylinders, into a combustion chamber for each cylinder. A direct-injection type diesel engine, in which fuel is injected and supplied directly into the combustion chamber, is employed for the engine. An intake port and exhaust port communicate respectively with the combustion chamber for each cylinder of the engine. An intake manifold and exhaust manifold are connected to each cylinder of the engine. An injector, which injects and supplies fuel into the combustion chamber, is provided for each cylinder of the engine.

An air cleaner, an intake throttle valve, a compressor of a turbocharger, an inter cooler, and a throttle valve are disposed in an intake pipe connected to the intake manifold. An intake passage communicating with the intake port of the engine is formed inside the intake manifold and the intake pipe. A turbine of the turbocharger and an exhaust gas purifier are disposed in an exhaust pipe connected to the exhaust manifold. An exhaust passage communicating with the exhaust port of the engine is formed inside the exhaust manifold and the exhaust pipe.

The exhaust passage on an upstream side of the turbine and the intake passage on a downstream side of the inter cooler are connected together by an EGR gas pipe. An EGR gas passage for recirculating (returning) EGR gas, which is a part of exhaust gas of the engine, from the exhaust passage to the intake passage, is formed inside this EGR gas pipe. An EGR gas flow rate control valve (hereinafter referred to as a high-pressure EGR control valve) for controlling a flow rate of EGR gas, which flows through the EGR gas passage, by its opening and closing operation, is disposed in the EGR gas pipe. As described above, the exhaust gas recirculation system (EGR system) configured such that the take-out port, from which EGR gas is taken out, is located on an upstream side of the turbine of the turbocharger, is referred to as a “high-pressure loop (HPL) EGR system”.

The exhaust passage on a downstream side of the turbine or exhaust gas purifier and the intake passage on an upstream side of the compressor are connected together by the EGR gas pipe. The EGR gas passage for recirculating (returning) EGR gas from the exhaust passage to the intake passage, is formed inside this EGR gas pipe. An EGR gas flow rate control valve (hereinafter referred to as a low-pressure EGR control valve) for controlling a flow rate of EGR gas, which flows through the EGR gas passage, by its opening and closing operation, is disposed in the EGR gas pipe. As described above, the exhaust gas recirculation system (EGR system) configured such that the EGR gas take-out port is located on a downstream side of the turbine of the turbocharger, is referred to as a “low-pressure loop (LPL) EGR system”.

The engine control system of the present embodiment includes the EGR system having both the high-pressure loop EGR system and low-pressure loop EGR system, and an engine control unit (electronic control unit: hereinafter referred to as ECU) which controls this EGR system. This engine control system is used as an exhaust control system for the engine that controls exhaust gas discharged from the combustion chamber for each cylinder of the engine. A valve module is incorporated into the low-pressure loop EGR system along the intake pipe, i.e., at a connecting portion of the intake pipe to the EGR gas pipe. This valve module is an EGR valve module in which a first valve 201 that is a valving element of a first control valve (exhaust gas control valve), and a second valve 202 that is a valving element of a second control valve (intake throttle valve), are disposed in a single valve housing 203.

The valve module used for the low-pressure loop EGR system includes two first and second valves 201, 202; a valve housing (intake duct) 203 which accommodates these first and second valves 201, 202 such that they can be opened and closed; an electric actuator which has a motor M which is a power source; a plate-like cam member (cam plate) that receives driving force (torque) of the motor M thereby to rotate; and a plate-like link member 208 (link arm: hereinafter referred to as a linking lever) that receives the torque of the motor M from this cam plate (a cam base 204, a cam frame 205 (outer and inner cam projection pieces 206, 207)), thereby to rotate. A columnar pivot pin 209 is fixed to an input part of the linking lever 208. A cylindrical cam follower (hereinafter referred to as a roller) 210 is rotatably supported by the outer circumference of the pivot pin 209.

The electric actuator includes the motor M which generates driving force (torque) for rotating respective shafts (rotatable shafts 211, 212) of the two first and second valves 201, 202; a power transmission mechanism (deceleration mechanism constituted of three reduction gears 214 to 216) which transmits the rotation of a motor shaft (output shaft) of this motor M to the cam plate; a coil spring 218 that urges the first valve 201 in its valve closing direction; and a coil spring 219 that urges the second valve 202 in its valve opening direction. Two first and second introduction passages 221, 222, a merging part 223, and one communication passage 224 are formed in the valve housing 203. A cylindrical first shaft bearing holding portion (bearing holder) 225 having a first shaft bearing hole therein, and a cylindrical second shaft bearing holding portion (bearing holder) 226 having a second shaft bearing hole therein are integrally provided for this valve housing 203.

The low-pressure EGR control valve that controls a flow rate of EGR gas, which flows through the first introduction passage 221, by its opening and closing operation is disposed inside the valve housing 203. This low-pressure EGR control valve includes the first valve 201 which opens and closes the first introduction passage 221, and the rotatable shaft 211 which is coupled with this first valve 201 in synchronization therewith. The first valve 201 is formed from refractory metal such as heat resisting aluminum alloy or heat resisting steel. This first valve 201 is a circular disk-like first valve body accommodated rotatably in the first introduction passage 221. The first valve 201 has a function of variably controlling an EGR rate, which is a ratio of the EGR gas amount to a total flow of intake air supplied into the combustion chamber for each cylinder of the engine as a result of the first valve 201 being rotated (opened or closed) in an operationable range from its fully closed position to fully open position. The first valve 201 is welded and fixed to a valve holding portion of the rotatable shaft 211.

A seal ring groove 228 having an annular shape that holds a seal ring 227 is formed on a peripheral end face of the first valve 201 continuously in a circumferential direction of the valve 201. The seal ring 227 is formed from refractory metal in an annular or C-shaped manner. The seal ring 227 is fitted and held in the seal ring groove 228 such that an inner circumferential side part of the ring 227 can move in the seal ring groove 228 in a radial direction, axial direction, and circumferential direction of the valve 201 with an outer circumferential side part of the ring 227 projecting radially outward of the peripheral end face of the first valve 201. The seal ring 227 is in sliding contact with an inner peripheral surface of a cylindrical nozzle 229, which is fitted in a nozzle fitted part of the valve housing 203. The rotatable shaft 211 of the first valve 201 is formed from refractory metal, similar to the first valve 201. This rotatable shaft 211 is a first shaft that supports and fixes the first valve 201. The rotatable shaft 211 is held rotatably by the first shaft bearing hole of the valve housing 203 through a first shaft bearing member (an oil seal 231, a bush 232, a bearing 233 and so forth). An axis line of this rotatable shaft 211 serves as a rotation center of the first valve 201, and also functions as a rotation center of the cam plate.

The intake throttle valve that controls a flow rate of intake air, which flows through the second introduction passage 222, by its opening and closing operation is provided inside the valve housing 203. This intake throttle valve includes the second valve 202 which opens and closes the second introduction passage 222, and the rotatable shaft 212 which is coupled with this second valve 202 in synchronization. The second valve 202 is formed from refractory metal similar to the first valve 201 or heat-resistant synthetic resin. This second valve 202 is a circular disk-like second valve body accommodated rotatably in the second introduction passage 222 and the merging part 223. The second valve 202 has a function of generating a predetermined negative pressure in the merging part 223 by being rotated (opened or closed) in an operationable range from its fully open position to fully closed position. The second valve 202 is fastened to a valve holding portion of the rotatable shaft 212 via a fastening screw with the valve 202 inserted into a valve insertion hole formed at the valve holding portion of the rotatable shaft 212. The rotatable shaft 212 of the second valve 202 is formed from refractory metal similar to the second valve 202 or heat-resistant synthetic resin. This rotatable shaft 212 is held rotatably by the second shaft bearing hole of the valve housing 203 through a second shaft bearing member (an oil seal 234, a bush 235, a bearing 236 and so forth). An axis line of the rotatable shaft 212 serves as a rotation center of the second valve 202, and also functions as a rotation center of the linking lever 208.

The valve housing 203 is formed from refractory metal such as heat resisting aluminum alloy or heat resisting steel. This valve housing 203 includes the first introduction passage 221 in which EGR gas flows; the second introduction passage 222 in which intake air flows; and the merging part 223 at which the two first and second introduction passages 221, 222 merges with the one communication passage 224. The first introduction passage 221 is an EGR gas introduction passage (first passage), in which EGR gas flows. This first introduction passage 221 communicates with the exhaust passage on a downstream side of the turbine of the turbocharger or the exhaust gas purifier through the EGR gas passage formed in the EGR gas pipe. An EGR gas (exhaust gas) introduction port (first port) for introducing EGR gas from the EGR gas pipe into the valve housing 203 is formed at an upstream end of the valve housing 203, i.e., at an upstream end of the first introduction passage 221 in the exhaust gas flow direction.

The second introduction passage 222 is an intake air introduction passage (second passage), in which intake air flows. This second introduction passage 222 communicates with the air cleaner through the intake passage formed inside the intake pipe on the air cleaner side. An intake air introduction port (second port) for introducing intake air from the intake pipe on the air cleaner side into the valve housing 203 is formed at the upstream end of the valve housing 203, i.e., at the upstream end of the second introduction passage 222 in the intake air flow direction. The communication passage 224 is a mixed gas guiding passage (third passage) in which the mixed gas of intake air and EGR gas or the intake air flows. This communication passage 224 communicates with the compressor of the turbocharger through the intake passage formed in the intake pipe on the engine side. A mixed gas guiding port (third port) for guiding out the mixed gas or intake air from the valve housing 203 into the intake pipe on the engine side is formed at a downstream end of the valve housing 203, i.e., at a downstream end of the communication passage 224 in the intake air flow direction. The first shaft bearing holding portion 225 is provided to surround the oil seal 231, the bush 232, and the bearing 233 in their circumferential direction. The first shaft bearing hole extending in the direction of the rotatable shaft of the low-pressure EGR control valve is formed inside this first shaft bearing holding portion 225. The second shaft bearing holding portion 226 is provided to surround the oil seal 234, the bush 235, and the bearing 236 in their circumferential direction. The second shaft bearing hole extending in the direction of the rotatable shaft of the intake throttle valve is formed inside this second shaft bearing holding portion 226.

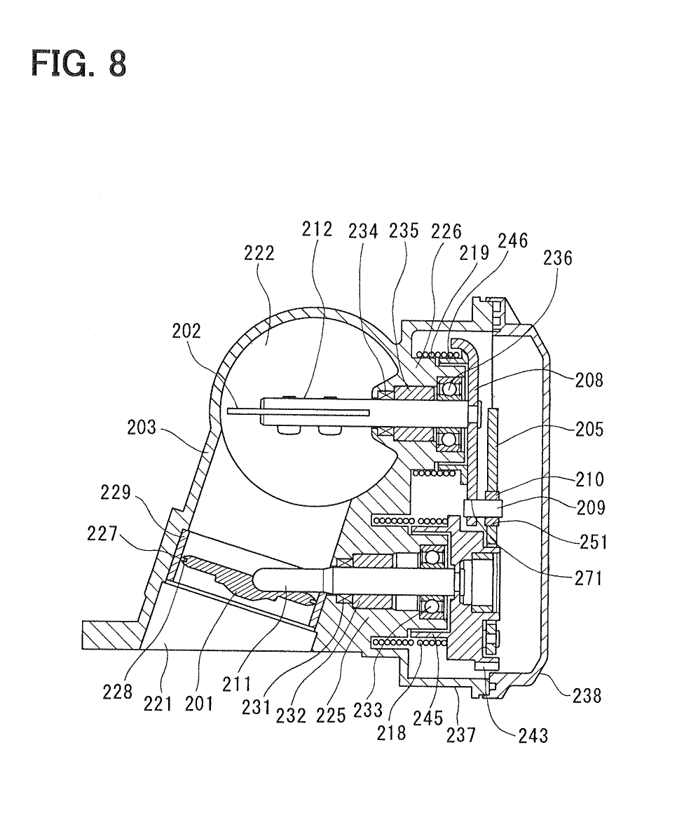

The electric actuator is a valve drive unit that drives the respective rotatable shafts 211, 212 of the two first and second valves 201, 202 via the cam plate and the linking lever 208, and the electric actuator performs opening and closing control upon the two first and second valves 201, 202. The electric actuator includes the motor M which is a power source, a deceleration mechanism that decelerates the rotation of the motor shaft of this motor M through two stages, and the coil springs 218, 219 that urge the two first and second valves 201, 202 in the valve closing direction and valve opening direction, respectively as illustrated in FIGS. 8 to 12. An actuator case of the electric actuator is constituted of a motor housing 237 that accommodates the motor M and the deceleration mechanism, and a cover (cover body) 238 that closes an opening of this motor housing 237. The motor housing 237 is attached integrally on an outer wall surface of the valve housing 203. Or, the housing 237 is formed integrally on an outer wall part of the valve housing 203. The motor M generates torque when supplied with electric power. This motor M is accommodated and held in a motor accommodating space of the motor housing 237. The motor M is electrically connected to a battery disposed in a vehicle such as an automobile via a motor drive circuit which is electronically controlled by the ECU.

The deceleration mechanism includes a pinion gear (motor gear) 214 which is coupled with the motor shaft of the motor M to be rotate together therewith, the intermediate gear 215 which is engaged with this motor gear 214 thereby to rotate, and the final gear 216 which is engaged with this intermediate gear 215 thereby to rotate. The deceleration mechanism includes an intermediate gear shaft (supporting shaft: hereinafter referred to as an intermediate gear shaft) 217 that is arranged in parallel relative to the respective rotatable shafts 211, 212 of the two first and second valves 201, 202 and the motor shaft of the motor M. The three reduction gears 214 to 216 are rotatably accommodated in a gear accommodating space of the motor housing 237.

The motor gear 214 is press-fitted and fixed into the outer circumference of the motor shaft. Projecting gear teeth (pinion gear part) 239 that are engaged with the intermediate gear 215 are formed on the outer circumference of this motor gear 214 entirely in a circumferential direction of the gear 214. The intermediate gear 215 is fitted rotatably around the outer circumference of the intermediate gear shaft 217. This intermediate gear 215 includes a cylindrical portion that is provided to surround the intermediate gear shaft 217 in the circumferential direction. A maximum external diameter part (larger diameter part) having an annular shape is formed integrally with the outer circumference of this cylindrical portion. Projecting gear teeth (major diameter gear part) 241, which are engaged with the projecting gear teeth 239 of the motor gear 214, are formed on the outer circumference of the larger diameter part of the intermediate gear 215 entirely in a circumferential direction of the gear 215. Projecting gear teeth (minor diameter gear part) 242 which are engaged with the final gear 216 are formed on the outer circumference of the cylindrical portion (smaller diameter part) entirely in the circumferential direction.

The final gear 216 is formed in fan-like fashion by a predetermined rotation angle. This final gear 216 includes projecting gear teeth (major diameter gear part having a fan-like shape) 243 which are engaged with the projecting gear teeth 242 of the intermediate gear 215. The final gear 216 includes an arc-shaped cam holding portion 244 which is fitted around the outer peripheral part of the cam plate. Therefore, the final gear 216 is provided integrally with the outer peripheral part of the cam plate. The intermediate gear shaft 217 is driven into a fitting hole of the motor housing 237, to be press-fitted and fixed in a fitted part of the motor housing 237. An axis line of this intermediate gear shaft 217 serves as a rotation center of the intermediate gear 215. The coil spring 218 is wound in a spiral manner around a cylindrical portion 245 that is formed integrally with the outer circumference of the first shaft bearing holding portion (cylindrical portion) 225 of the valve housing 203 and the final gear 216 (or cam plate). The coil spring 219 is wound in a spiral manner around a cylindrical portion 246 that is formed integrally with the outer circumference of the second shaft bearing holding portion (cylindrical portion) 226 of the valve housing 203 and the linking lever 208.

The cam plate is formed into a predetermined shape from metal or synthetic resin, and is disposed to be exposed to the outside of the valve housing 203. Furthermore, the cam plate is rotatably accommodated in the gear accommodating space of the motor housing 237, similar to the deceleration mechanism. This cam plate is configured to rotate with the rotatable shaft 211 being its center on receiving the driving force of the electric actuator. The cam plate includes the above-described final gear 216, a cam base 204 that is rotated together with the rotatable shaft 211 of the first valve 201 on receiving motor torque from this final gear 216, and a cam frame 205 which transmits the motor torque to the linking lever 208.

An input part which receives the motor torque from the final gear 216, and a first output part (first driving unit) that rotates the rotatable shaft 211 of the first valve 201 in synchronization with the rotation of the cam plate are provided for the cam base 204 of the cam plate. The input part of the cam base 204 is fixed integrally to the cam holding portion 244 of the final gear 216. Or, the cam plate is formed integrally with the inner circumferential portion of the final gear 216. A fitting hole 249, into which the rotatable shaft 211 of the first valve 201 is fitted, is formed in the first output part of the cam base 204. Accordingly, the rotatable shaft 211 of the first valve 201 is coupled with the first output part of the cam plate in an integrally rotatable manner.

A second output part (second driving unit) that rotates the rotatable shaft 212 of the second valve 202 in synchronization with the rotation of the cam plate is provided for the cam frame 205 of the cam plate. The second output part of this cam frame 205 includes a cam groove 251 that drives the linking lever 208 in synchronization with the rotation of the cam plate. The cam groove 251 is formed so as to rotate the rotatable shaft 212 of the second valve 202 in an operation pattern different from the first valve 201 in accordance with the rotation of the cam plate by means of the combination of more than one (two) circular arc grooves 252, 253 having different curvature radiuses and curvature centers from one another. A cam profile having a shape corresponding to the operation pattern of the second valve 202, which is different from the first valve 201, is formed on both side surfaces of this cam groove 251 in its groove width direction. Outer and inner cam projection pieces 206, 207 are formed integrally with the second output part of the cam frame 205 to project into the outside from the outer peripheral part of the cam base 204.

The cam groove 251 is formed inside the cam frame 205, between the cam base 204 and the outer cam projection piece 206, and between the outer and inner cam projection pieces 206, 207. This cam groove 251 is a guide groove that guides the pivot pin 209 and the roller 210 in the formation direction of the cam groove 251 to rotate the linking lever 208 in synchronization with the rotation of the cam plate. The circular arc groove 252 of the cam groove 251 has a predetermined curvature radius with the rotation center of the cam plate being the center of curvature. The circular arc groove 253 of the cam groove 251 has the region that is different from the rotation center of the cam plate as its center of curvature, and the groove 253 has a curvature radius smaller than the circular arc groove 252. The circular arc groove 252 indicates a non-synchronization section (non-synchronization section in the cam groove 251) in which the two first and second valves 201, 202 are not synchronized with each other by fixing the second valve 202 at its fully open position irrespective of the opening/closing state of the first valve 201 while the rotation angle of the cam plate changes from the minimum value (e.g., 0 degrees) to the intermediate value (e.g., 50 degrees). A groove side face of the circular arc groove 252 is formed on an outer lateral surface of the cam base 204. The circular arc groove 253 indicates a synchronization section (synchronization section in the cam groove 251), in which the two first and second valves 201, 202 are synchronized with each other so as to close the second valve 202 in accordance with the valve opening action of the first valve 201 during the change of the rotation angle of the cam plate from the intermediate value (e.g., 50 degrees) to the maximum value (e.g., 90 degrees). Groove side faces of the circular arc grooves 252, 253 are formed on an inner lateral surface of the outer cam projection piece 206. A groove side face of the circular arc groove 253 is formed on an outer lateral surface of the inner cam projection piece 207.

The outer cam projection piece 206 extends, curving radially outward of the outer peripheral part of the cam base 204, and from one end side (second-valve fully-open side) toward the other end side (second-valve fully-closed side) of the cam groove 251 in its formation direction. The inner cam projection piece 207 extends toward the second-valve fully-closed side, from the outer peripheral part of the cam base 204 to the other end side (second-valve fully-closed side) of the cam groove 251 in its formation direction. A joining section 254 that couples together the cam base 204 and the outer cam projection piece 206 in a semicircular manner to limit further displacement of the pivot pin 209 and the roller 210 toward the second-valve fully-open side is formed at the second-valve fully-open side (one end side) end of the cam groove 251 in its formation direction. Open end parts (open end parts of the outer and inner cam projection pieces 206, 207 of the cam plate) 261, 262 that open into the outside of the cam plate are formed at the second-valve fully-closed side (the other end side) end of the cam groove 251 in the formation direction of the circular arc groove 253. The open end part 261 of the outer cam projection piece 206 and the open end part 262 of the inner cam projection piece 207 open on the second-valve fully-closed side (the other end side) of the cam groove 251 in its formation direction. The position of the open end part 261 of the outer cam projection piece 206 is set further on the second-valve fully-open side (one end side) of the cam groove 251 in its formation direction than the position of the open end part 262 of the inner cam projection piece 207 by a predetermined distance. A cam groove opening 263 that opens on cam frame end faces (open end parts 261, 262) of the cam plate is formed at the outer and inner cam projection pieces 206, 207 of the cam frame 205 of the cam plate.

The size of the cam plate is further decreased than FIG. 3; and for the purpose of reliably preventing (limiting) the interference between the cam plate and the motor gear 214, at least the portion that is unnecessary for the opening and closing operation of the second valve 202 is eliminated (removed) from an overlapping part of the cam frame 205 of the cam plate that overlaps with the motor M and the motor gear 214. Particularly, for the purpose of reliably preventing (limiting) the interference between the cam frame 205 and the motor M or the motor gear 214, the entire overlapping part of the outer cam projection piece 206 serving as a main part of the cam frame 205 that overlaps with the motor M and the motor gear 214 is eliminated (removed). A distance from a limit position of a moving range of the roller 210 on its one side (fully closed position of the second valve 202) along the outer cam projection piece 206 of the cam frame 205 to the end face of the open end part 261 is set in view of such an allowance as to avoid the separation of the roller 210 from the cam groove 251. More specifically, the size of the cam groove 251 in its formation direction is obtained as a result of the addition of the allowance to the entire moving range of the roller 210 (axis line distance of the circular arc grooves 252, 253 from the fully closed position of the first valve 201 as well as the fully open position of the second valve 202 to the fully open position of the first valve 201 as well as the fully closed position of the second valve 202).

The linking lever 208 is formed into a predetermined shape from metal or synthetic resin, and is disposed to be exposed to the outside of the valve housing 203. Furthermore, the linking lever 5 is rotatably accommodated in the gear accommodating space of the motor housing 237, similar to the deceleration mechanism. An input part that receives the torque of the motor M of the electric actuator from the cam plate is provided for the one end part of the linking lever 208. An output part that rotates the rotatable shaft 212 of the second valve 202 in synchronization with the rotation of the cam plate is provided at the rotation center part of the linking lever 208. A fitting hole 271, into which the pivot pin 209 is fitted, is formed at the input part of the linking lever 208. A fitting hole 272, into which the rotatable shaft 212 is fitted, is formed at the output part of the linking lever 208. Accordingly, the rotatable shaft 212 of the second valve 202 is coupled with the output part of the linking lever 208 in an integrally rotatable manner.

The pivot pin 209 and the roller 210 are inserted (engaged) movably in the circular arc grooves 252, 253 of the cam groove 251 of the cam plate. These pivot pin 209 and the roller 210 are guided in the formation direction of the cam groove 251 along a groove side face (cam profile) of the circular arc grooves 252, 253. The pivot pin 209 is formed into a predetermined shape from metal, and driven into the fitting hole 271 of the linking lever 208 to be press-fitted and fixed to the input part of the linking lever 208. The axis line of this pivot pin 209 serves as the rotation center of the roller 210. The roller 210 is formed into a cylindrical shape from metal, and fitted rotatably around the outer circumference of the pivot pin 209. This roller 210 includes a cylindrical portion to surround the pivot pin 209 in the circumferential direction.

Operation of the fourth embodiment will be described below. Workings of the valve module that is incorporated into the low-pressure loop EGR system of the present embodiment will be briefly described in reference to FIGS. 8 to 12.

The motor M of the electric actuator of the present embodiment is configured to be energization-controlled by the ECU. When electric power is not supplied to the motor M, an opening degree of the first valve 201 is set to be at a fully closed position to fully close the first introduction passage 221 by urging force (spring force) of the coil spring 218. Thus, the first valve 201 is put in a fully closed state so that the first introduction passage 221 is closed. Meanwhile, an opening degree of the second valve 202 is set to be at a fully open position to fully open the second introduction passage 222 and the merging part 223 by urging force (spring force) of the coil spring 219. Thus, the second valve 202 is in a fully open state so that the second introduction passage 222 and the merging part 223 are opened. Accordingly, the EGR gas is not mixed into into fresh air (clean intake air filtered through the air cleaner).

In the case of the valve opening operation of the first valve 201 within a range from the fully closed opening degree to intermediate opening degree, the electric power supply to the motor M of the electric actuator is controlled such that the rotation angle of the cam plate reaches a predetermined value that is within a range from the minimum value (e.g., 0 degrees) to an intermediate value (e.g., 50 degrees), to perform the opening and closing control of the first valve 201 in accordance with an operation condition (operational state) of the engine and to maintain the fully open state of the second valve 202. Accordingly, the motor shaft of the motor M is rotated in a fully-open direction. As a result, the torque (motor torque) of the motor M is transmitted to the motor gear 214, the intermediate gear 215, and the final gear 216. Then, the cam plate, to which the motor torque is transmitted from the final gear 216, rotates in the valve opening direction by a predetermined rotation angle (rotation angle that is the same as the operating angle of the final gear 216) in accordance with the rotation of the final gear 216.

Meanwhile, despite the rotation of the cam plate around the rotatable shaft 211 by the predetermined rotation angle, since the circular arc groove 252 of the cam groove 251 of the cam plate has a curvature radius with the rotatable shaft 211 being its center of curvature, the motor torque is not transmitted from the groove side face of the circular arc groove 252 to the pivot pin 209, which is fixed to the input part of the linking lever 208, and the roller 210, and the positions of the pivot pin 209 and the roller 210 do not change. Accordingly, even though the cam plate rotates and the pivot pin 209 and the roller 210 are displaced from the first valve fully closed position to first valve intermediate position of the cam groove 251, the linking lever 208 does not rotate around the rotatable shaft 212. Therefore, the degree of opening of the second valve 202 does not change. As a result, the rotation angle of the cam plate is changed to the predetermined value (predetermined rotation angle) within the range from the minimum value to the intermediate value, and the rotation angle of the linking lever 208 is stopped at an angle, at which the fully open state of the second valve 202 is maintained. Consequently, the first valve 201 is opened by an opening degree that is in accordance with the engine operation condition, and the second valve 202 continues its fully open state. Therefore, the two first and second introduction passages 221, 222 are opened.

Thus, the EGR gas, which is taken into the EGR gas passage from the exhaust passage on the downstream side of the turbine of the turbocharger or the exhaust gas purifier, flows in through an EGR gas introduction port of the valve housing 203. This EGR gas is then introduced into the merging part 223 of the valve housing 203 through the first introduction passage 221 of the valve housing 203. The intake air, which is filtered through the air cleaner, flows in through an intake air introduction port of the valve housing 203. This intake air is then introduced into the merging part 223 of the valve housing 203 through the second introduction passage 222 of the valve housing 203. After that, the EGR gas and intake air are mixed together to become the mixed gas in the merging part 223 and the communication passage 224. The mixed gas flows into the intake port for each cylinder of the engine through the intake passage formed inside the intake pipe on the engine side and the intake manifold. The mixed gas is then introduced into the combustion chamber for each cylinder of the engine from each intake port. As a consequence, harmful substances (e.g., NOx) contained in the exhaust gas from the engine can be reduced.

In the case of valve opening operation of the first valve 201 within the range from the intermediate opening degree to fully open opening degree, the electric power supply to the motor M of the electric actuator is controlled such that the rotation angle of the cam plate reaches a predetermined value within the range from the intermediate value to the maximum value (e.g., 90 degrees) to perform the opening and closing control of the two first and second valves 201, 202 in accordance with the engine operation condition. Accordingly, the motor shaft of the motor M is rotated further in the fully-open direction. As a result, the motor torque is transmitted to the motor gear 214, the intermediate gear 215, and the final gear 216. Then, the cam plate, to which the motor torque is transmitted from the final gear 216, rotates further in the valve opening direction by a predetermined rotation angle in accordance with the rotation of the final gear 216.

As a result, the pivot pin 209 of the linking lever 208 and the roller 210 enter from the circular arc groove 252 to the circular arc groove 253 of the cam groove 251 of the cam plate. Then, the pivot pin 209 and the roller 210 moves along the groove side face of the circular arc groove 253 of the cam groove 251, rolling thereon (being engaged therewith) in the range from the first valve intermediate position to first valve fully open position of the cam groove 251. In consequence, the motor torque is transmitted from the groove side face of the circular arc groove 253 of the cam groove 251 of the cam plate to the pivot pin 209 of the linking lever 208 and the roller 210, and the linking lever 208 thereby rotates in the valve closing direction around the rotatable shaft 212. Accordingly, inversely with the rotation of the first valve 201 in the fully open direction around the rotatable shaft 211 in accordance with the rotation of the cam plate and the rotatable shaft 211, the second valve 202 rotates around the rotatable shaft 212 in the valve closing direction in accordance with the rotation of the rotatable shaft 212.

Thus, the rotation angle of the cam plate is changed to a predetermined value (predetermined rotation angle) within the range from the intermediate value to the maximum value; and the rotation angle of the linking lever 208 is changed to a predetermined value (predetermined rotation angle) within the range from the second valve fully open position to second valve fully closed position. Accordingly, the first valve 201 is opened by the opening degree that is in accordance with the engine operation condition; and the second valve 202 is closed by the degree of opening corresponding to the engine operation condition. As a result, the first introduction passage 221 is opened and a passage sectional area of the second introduction passage 222 is reduced. Therefore, in the operating range in which the large amount of EGR gas is recirculated by means of the low-pressure loop EGR system, the first valve 201 is opened and the second valve 202 is closed to increase a differential pressure between the exhaust passage side and intake passage side. Thus, using the low-pressure loop EGR system, the large amount of EGR gas can be returned into the intake port and combustion chamber for each cylinder of the engine.

Characteristics of the fourth embodiment will be described below. As described above, for the purpose of preventing the interference between the cam plate having the cam groove 251 for guiding the roller 210 supported by the pivot pin 209, which is fixed to the linking lever 208, and the motor M or the motor gear 214 by reducing the size of (by downsizing) the cam plate, the valve module used for the low-pressure loop EGR system of the present embodiment includes the first valve 201, which is a valving element of the low-pressure EGR control valve; the second valve 202 which is a valving element of the intake throttle valve; the valve housing 203, in which the two first and second valves 201, 202 are disposed; the cam plate that receives the motor torque from the final gear 216 to rotate together with the rotatable shaft 211 of the first valve 201; the linking lever 208 that receives the motor torque from this cam plate to rotate together with the rotatable shaft 212 of the second valve 202; the pivot pin 209 that is inserted movably in the cam groove 251 of the cam plate; and the roller 210 supported by this pivot pin 209.

For the purpose of further decreasing the size of (downsizing) the cam plate than FIG. 3 and reliably preventing (limiting) the interference between the cam plate and the motor gear 214, at least the portion that is unnecessary for the opening and closing operation of the second valve 202 is eliminated (removed) from an overlapping part of the cam frame 205 of the cam plate that overlaps with the motor M and the motor gear 214. Particularly, for the purpose of reliably preventing (limiting) the interference between the cam frame 205 and the motor M or the motor gear 214, the entire overlapping part of the outer cam projection piece 206 serving as a main part of the cam frame 205 that overlaps with the motor M and the motor gear 214 is eliminated (removed).

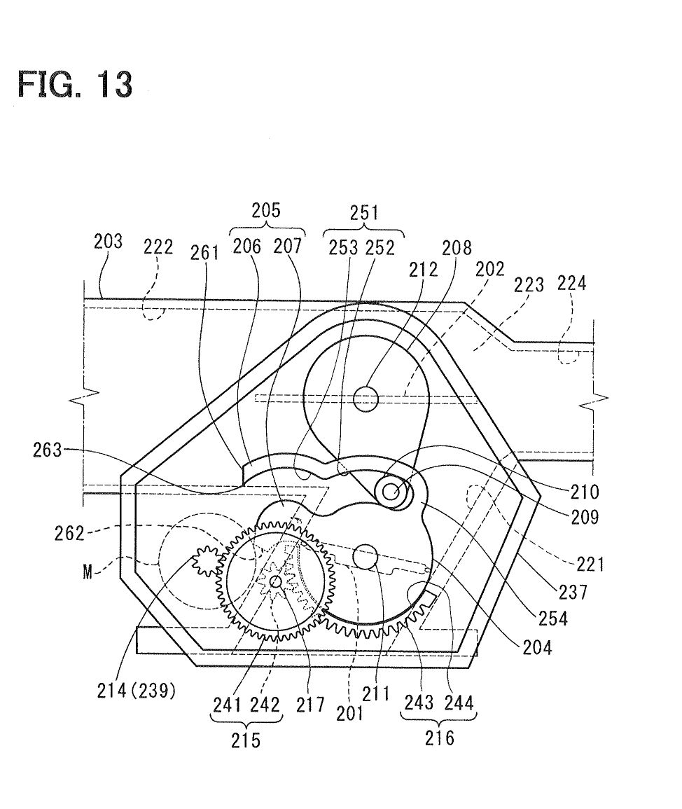

As a result of the elimination (removal) of a portion (motor-side portion of the cam frame 205 in its rotation direction) of the cam frame 205 of the cam plate that is highly likely to interfere with the motor M or the motor gear 214, the cam plate can be downsized compared to the conventional technology and FIG. 3, and the interference between the cam plate and the motor M or the motor gear 14 can reliably be prevented (limited). Moreover, a degree of allowance for the interference between the cam frame 205 and the motor M or the motor gear 214 can be improved without increasing a clearance between the cam frame 205 of the cam plate and the motor gear 214 in the rotation axis direction. In addition, an inter-axial pitch between the motor shaft, which is a motor gear shaft of the motor gear 214 and the intermediate gear shaft 217, which is an intermediate gear shaft of the intermediate gear 215 can be reduced. Accordingly, the setting position of the motor M can be changed suitably. For example, the setting position can be changed to a position that is offset from the present installation position (see FIGS. 9 to 12) to one end side of the cam groove 251 in its formation direction (see FIG. 13). Accordingly, because the entire system can be downsized, the entire valve module can be downsized. Thus, the installability of the valve module in the engine compartment of the vehicle such as an automobile can be improved.

### Fifth Embodiment

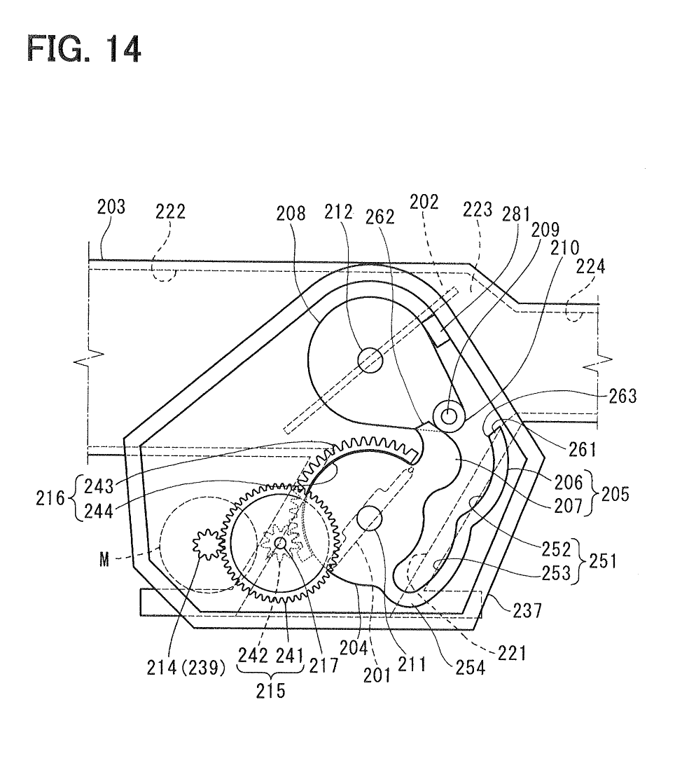

FIG. 14 illustrates a fifth embodiment of the invention, and is a diagram illustrating operating states of a cam plate and a linking lever when a low-pressure EGR control valve is fully closed.

Similar to the fourth embodiment, the valve module used for the low-pressure loop EGR system of the present embodiment includes two first and second valves 201, 202 that open and close a passage (two first and second introduction passages 221, 222) communicating with the combustion chamber of the engine; a valve housing 203 in which these first and second valves 201, 202 are disposed; a cam plate which drives a rotatable shaft 211 of the first valve 201; a linking lever 208 which drives a rotatable shaft 212 of the second valve 202; and an electric actuator that opens and closes the two first and second valves 201, 202 through the cam plate, the linking lever 208, a roller 210 and so forth. A motor M of the electric actuator is configured to be energization-controlled by an ECU.

When the first valve 201 is used as a valving element of the low-pressure EGR control valve, and the second valve 202 is used as a valving element of the intake throttle valve, the second valve 202 may move (flap) in its rotation direction due to the influence of engine vibration, and suction pulsation pressure from the engine (or exhaust pulsation pressure). In a case where an open end part 261 of an outer cam projection piece 206 and an open end part 262 of an inner cam projection piece 207 open on the other end side of a cam groove 251 in its formation direction (fully-closed position side of the second valve 202), if the second valve 202 flaps due to the influence of suction pulsation pressure (or exhaust pulsation pressure) caused by engine vibration or opening and closing of an intake valve (or exhaust valve) when the first valve 201 is rotated to its fully-open position, and the second valve 202 is rotated to its fully closed position, as illustrated in FIG. 12, the roller 210, which is fitted around the outer circumference of a pivot pin 209 fixed to the linking lever 208 may be separated from the cam groove 251 of a cam frame 205 of the cam plate.

In the valve module of the present embodiment, a stopper (valve holding means) 281, with which the linking lever 208 is in contact and which holds the second valve 202 at its fully-closed position, is provided for the purpose of preventing (limiting) the flapping of the second valve 202 and preventing (limiting) the separation of the roller 210 from the cam groove 251 of the cam frame 205. This stopper 281 is provided integrally with an inner wall surface of the motor housing 237. In this case, it is only necessary to change the shape of the motor housing 237, so that cost rising can be limited. In addition, the second valve 202 does not flap due to the engine vibration and suction pulsation pressure (or exhaust pulsation pressure) because of the restriction of further rotation of the second valve 202 in its fully-closed direction as a result of the linking lever 208 having been brought into contact with the stopper 281. Accordingly, detachment of the roller 210 of the linking lever 208 from the cam groove 251 of the cam frame 205 can be prevented. As a result, the operational reliability of the cam plate and the linking lever 208 can be improved. Alternatively, the rotation movement of the second valve 202 or the rotatable shaft 212 may be restricted by a valve holding means such as a stopper, which is in direct contact with the second valve 202 or the rotatable shaft 212.

Modifications to the above embodiments will be described below. In the above embodiments, the exhaust system (exhaust gas recirculation system) for the engine of the invention is applied to the valve module of the low-pressure loop EGR system (including the valve unit of the low-pressure EGR control valve and the intake throttle valve). Alternatively, the exhaust system (exhaust gas recirculation system) for the engine of the invention may be applied to a valve module of the high-pressure loop EGR system (including a valve unit of the high-pressure EGR control valve and a throttle valve). In the above embodiments, the exhaust system for the engine of the invention is applied to the valve module of the exhaust gas recirculation system. Alternatively, the exhaust system for the engine of the invention may be applied to a valve module including a waste gate valve for opening and closing a bypass flow passage that bypasses the turbine of the turbocharger, and an exhaust gas flow control valve (or a passage switch valve) for adjusting the flow rate of exhaust gas introduced into the turbine.

In the above embodiments, the other end side of the cam groove 251 of the cam frame 205 of the cam plate in its formation direction is eliminated (removed). Instead, one end side of the cam groove 251 of the cam frame 205 of the cam plate in its formation direction may be eliminated (removed). In the above embodiments, the actuator (valve drive unit) for opening and closing the two first and second valves 201, 202 is configured by the electric actuator having the motor M and the deceleration mechanism. Alternatively, the actuator that opens and closes the two first and second valves 201, 202 may also be configured by a negative pressure-operated actuator having an electromagnetic or electric-powered negative pressure control valve, or an electromagnetic actuator provided with an electromagnet including a coil. Moreover, not only a diesel engine but a gasoline engine may also be used for the internal combustion engine (e.g., an engine for traveling) disposed in the vehicle such as an automobile. In addition, not only a multi-cylinder engine but a single cylinder engine may also be employed as the internal combustion engine (engine).

In the above embodiments, the valve module is configured such that the exhaust gas (EGR gas) flows inside the first introduction passage (first passage) 221, and that the intake air flows inside the second introduction passage (second passage) 222. Alternatively, the valve module may be configured such that the intake air flows inside the first introduction passage (first passage) 221, and that the exhaust gas flows inside the second introduction passage (second passage) 222. In this case, the first valve that controls (the flow rate of) intake air flowing through the first passage by its opening and closing operation serves as the valving element of the intake throttle valve, and the second valve that controls (the flow rate of) exhaust gas flowing through the second passage by its opening and closing operation serves as the valving element of the low-pressure EGR control valve.

To sum up, the exhaust gas recirculation system of the above embodiments may be described as follows.

The exhaust gas recirculation system includes a housing having a merging part that merges two first and second passages into one passage, two first and second valves that are accommodated rotatably in this housing, an actuator that opens and closes these first and second valves, a cam member that receives power of this actuator thereby to rotate, and a link member that receives the power of the actuator through this cam member thereby to rotate. The first valve is configured to open and close the first passage to control (the flow rate of) exhaust gas or intake air which flows through the first passage. The second valve is configured to open and close the second passage to control (the flow rate of) intake air or exhaust gas which flows through the second passage. The cam member is coupled with the first valve to synchronize with the first valve (e.g., such that the first valve is rotatable together with the cam member). The cam member includes a cam groove along which the link member is driven in synchronization with the rotation of this cam member, and an open end part that is formed on one end side of this cam groove in its formation direction to open into the outside of the cam member. The link member is coupled with the second valve to synchronize with the second valve (e.g., such that the second valve is rotatable together with the link member). In addition, the link member includes a roller guided along the cam groove.

According to the invention, the open end part of the cam member (or cam groove) is formed through the elimination (removal) of an unnecessary cam groove portion, into which the roller does not enter over the entire operating range (entire moving range) of the second valve from a portion of the cam member that overlaps with the actuator. Accordingly, the cam member can be downsized, and the interference between the cam member and the actuator can be prevented (limited) in comparison with the conventional technology provided with the cam member including the portion which overlaps the actuator, and an unnecessary cam groove portion, into which the roller does not enter along the entire operating range of the second valve. Moreover, because the allowance for the interference between the cam member and the actuator can be improved without increasing a clearance between the cam member and the actuator in their rotation axis directions, the entire system can be reduced in size. As a result, the installability of the system in, for example, a vehicle, can be improved.

According to the invention, the cam member is provided with a cam base including the rotation center part of the cam member, and a cam projection piece extending in a formation direction of the cam groove radially outward of this cam base. Accordingly, the shape of the cam member can be simplified, and the cam member can be downsized. Thus, the production cost of the cam member can be decreased. According to the invention, the cam projection piece constitutes a low-strength part having lower strength than the cam base. The cam member includes a bridge-like reinforcement part that connects a freely end portion of the cam projection piece to the cam base. Consequently, since the cam projection piece, which is a low-strength part, is reinforced, the mechanical strength of the entire cam member is improved, and the operational reliability and durability of the cam member become high. According to the invention, because the bridge-like reinforcement part is disposed at the position which does not interfere with the roller, the interference between the bridge-like reinforcement part and the roller can be prevented, and the operational reliability of the cam member and the link member can thereby be improved.

According to the invention, the cam projection piece constitutes a low-strength part having lower strength than the cam base. The cam member includes a plate-like reinforcement part covering the entire groove surface of the cam groove. Consequently, since the cam projection piece, which is a low-strength part, is reinforced, the mechanical strength of the entire cam member is improved, and further improvement in operational reliability and durability of the cam member can be expected. Moreover, a function as a dust-entry prevention cover for preventing (limiting) the entering of dust into between a side surface of the cam groove of the cam member and an outer peripheral surface of the roller, can also be given to the plate-like reinforcement part. According to the invention, because the plate-like reinforcement part is disposed at the position which does not interfere with the roller, the interference between the plate-like reinforcement part and the roller can be prevented, and the operational reliability of the cam member and the link member can thereby be improved.

According to the invention, by means of the combination of circular arc grooves having different curvature radii and curvature centers, the cam groove of the cam member is formed to rotate the second valve in an operation pattern different from the first valve in accordance with the rotation of the cam member. In this case, when the power of the actuator is transmitted to the cam member, the two first and second valves are opened or closed independently of each other. According to the invention, the cam groove of the cam member includes a cam profile having a shape in accordance with the operation pattern of the second valve. In this case, when the power of the actuator is transmitted to the cam member, the two first and second valves are opened or closed independently of each other. According to the invention, the link member includes a pivot which receives the power of the actuator from the cam member through the roller. This pivot is inserted movably in the cam groove of the cam member.

To sum up, the exhaust system for the engine of the above embodiments may be described as follows.

The exhaust system for the engine includes a housing having a merging part that merges two first and second passages into one passage, two first and second valves that are accommodated rotatably in this housing, a motor which is a power source for driving these two first and second valves, an actuator which has a deceleration mechanism for decelerating the rotation of an output shaft of this motor, a cam member that receives power of the motor thereby to rotate, and a link member that receives the power of the motor through this cam member thereby to rotate. The first valve is configured to open and close the first passage to control (the flow rate of) exhaust gas or intake air which flows through the first passage. The second valve is configured to open and close the second passage to control (the flow rate of) intake air or exhaust gas which flows through the second passage.

The deceleration mechanism of the actuator includes a motor gear coupled with the output shaft of the motor in an integrally rotatable manner, an intermediate gear engaged with this motor gear thereby to rotate, and a final gear engaged with this intermediate gear thereby to rotate. The cam member includes a cam base that receives power of the motor from the final gear to rotate together with the first valve, and a cam frame which transmits the power of the motor to the link member. The cam base is disposed to rotate together with the final gear, and connected to the first valve so as to synchronize with the first valve (e.g., such that the first valve is rotatable together with the cam base). A cam groove, which drives the link member in synchronization with the rotation of the cam member, is formed inside the cam frame. The link member includes a roller guided along the cam groove, and is coupled with the second valve to synchronize therewith (e.g., such that the second valve is rotatable together with the link member).

According to the invention, at least the portion that is unnecessary for the operation of the second valve is eliminated (cut off) from an overlapping part of the cam frame with the cam groove therein, which overlaps with the motor and the motor gear. As a result of the elimination (removal) of a portion of the cam frame of the cam member that is highly likely to interfere with the motor or the motor gear (i.e., a motor-side portion of the cam frame in its rotation direction), the cam member can be downsized compared to the conventional technology, and the interference between the cam member and the motor or the motor gear can reliably be prevented (limited). Moreover, a degree of allowance for the interference between the cam frame of the cam member and the motor or the motor gear can be improved without increasing a clearance between the cam frame of the cam member and the motor gear in the rotation axis direction. In addition, an inter-axial pitch between a motor gear shaft (e.g., output shaft of the motor) and an intermediate gear shaft can be made smaller. Accordingly, the setting position of the motor can be changed suitably, and the entire system can be downsized. As a result, the installability of the system in, for example, a vehicle, can be improved.

According to the invention, an intermediate gear shaft arranged in parallel relative to the output shaft of the motor (motor gear shaft) is provided for the deceleration mechanism. The intermediate gear is supported rotatably around this intermediate gear shaft. According to the invention, the cam base of the cam member is configured to include a rotation center part of the cam member. The cam frame of the cam member includes an outer cam projection piece extending radially outward of the cam base as well as from one end side toward the other end side of the cam groove in its formation direction; and an inner cam projection piece extending from the outer peripheral part of the cam base toward the other end side of the cam groove in its formation direction. Accordingly, since the shape of the cam member can be simplified, and the cam member can be downsized, the production cost of the cam member can be decreased. According to the invention, the cam groove, which drives the link member in synchronization with the rotation of the cam member, is formed between the outer cam projection piece and the cam base; and between the outer cam projection piece and inner cam projection piece. In addition, the roller which is guided along the cam groove is provided for the link member. As a result, the cam groove serves as a guide groove for guiding the roller in the formation direction of the cam groove to rotate the link member in synchronization with the rotation of the cam member.

According to the invention, the entire overlapping part of the outer cam projection piece that overlaps with the motor or the motor gear is eliminated (cut off). According to the invention, the outer cam projection piece and inner cam projection piece include an open end part that opens into the outside of the cam frame, on the other end side of the cam groove in its formation direction. According to the invention, the position of the open end part of the outer cam projection piece is set further on one end side of the cam groove in its formation direction than the position of the open end part of the inner cam projection piece. As a result of the elimination (removal) of a portion of the cam frame of the cam member that is highly likely to interfere with the motor or the motor gear (i.e., a motor-side portion of the outer cam projection piece in its rotation direction), the cam member can be downsized compared to the conventional technology, and the interference between the cam member and the motor or the motor gear can reliably be prevented (limited). Moreover, a degree of allowance for the interference between the outer cam projection piece of the cam frame and the motor or the motor gear can be improved without increasing a clearance between the outer cam projection piece of the cam frame and the motor gear in the rotation axis direction. In addition, an inter-axial pitch between a motor gear shaft (e.g., output shaft of the motor) and an intermediate gear shaft can be made smaller. Consequently, the setting position of the motor can be changed suitably (e.g., the installation position is shifted to a position that is offset from the present installation position to one end side of the cam groove in its formation direction), and the entire system can be downsized. As a result, the installability of the system in, for example, a vehicle, can be improved.

According to the invention, the open end part of the outer cam projection piece, and the open end part of the inner cam projection piece open on the fully-closed position side of the second valve. If the two first and second valves are used as a valving element of an intake control valve for opening and closing a passage communicating with the engine, or a valving element of an exhaust control valve, the second valve may move (flap) in its rotation direction due to the influence of vibration of the engine, and suction pulsation pressure or exhaust pulsation pressure of the engine. In the case where the open end part of the outer cam projection piece, and the open end part of the inner cam projection piece open on the fully-closed position side of the second valve, if the second valve flaps, the roller of the link member may fall off from the cam groove of the cam frame. Consequently, according to the invention, by providing a valve holding means for holding the second valve at its fully-closed position, the flapping of the second valve because of the vibration of the engine, and suction pulsation pressure or exhaust pulsation pressure of the engine, for example, can be prevented. Accordingly, detachment of the roller of the link member from the cam groove of the cam frame can be prevented.

According to the invention, by means of the combination of circular arc grooves having different curvature radii and curvature centers, the cam groove is formed to rotate the second valve in an operation pattern different from the first valve in accordance with the rotation of the cam member. In this case, when the power of the motor is transmitted to the cam member, the two first and second valves are opened or closed independently of each other. According to the invention, the cam groove includes a cam profile having a shape in accordance with the operation pattern of the second valve. In this case, when the power of the motor is transmitted to the cam member, the two first and second valves are opened or closed independently of each other. According to the invention, the link member includes a pivot which receives the power of the motor from the cam base of the cam member through the roller. This pivot is inserted movably in the cam groove. According to the invention, the exhaust system for the engine is applied to the exhaust gas recirculation system that mixes exhaust gas from the engine with intake air and returns it into the engine.

Additional advantages and modifications will readily occur to those skilled in the art. The invention in its broader terms is therefore not limited to the specific details, representative apparatus, and illustrative examples shown and described.

What is claimed is:

1. An exhaust gas recirculation system adapted for an internal combustion engine, for mixing exhaust gas of the engine into intake air and for recirculating mixed gas of the intake air and the exhaust gas to the engine, the system comprising:
a housing that includes first and second passages, a communication passage, and a merging part which merges the first and second passages into the communication passage;
first and second valves that are accommodated rotatably in the housing and are configured to open or close the first and second passages, respectively;
an actuator that is configured to drive the first and second valves to open or close the first and second passages, respectively;
a cam member that is coupled with the first valve to be in synchronization therewith and that receives power of the actuator thereby to rotate; and
a link member that is coupled with the second valve to be in synchronization therewith and that receives the power of the actuator through the cam member thereby to rotate, wherein the cam member includes:
a cam groove along which to drive the link member to rotate in synchronization with the rotation of the cam member, the link member including a roller that is guided along the cam groove;
an open end part that is formed on one end side of the cam groove in its formation direction and opens outward of the cam member; and
an overlapping part that overlaps with the actuator, the open end part being formed as a result of elimination of a part unnecessary for movement of the second valve from the overlapping part.

2. The exhaust gas recirculation system according to claim 1, wherein the cam member further includes:
a cam base that includes a rotation center part of the cam member; and
a cam projection piece that extends radially outward of the cam base in the formation direction of the cam groove.

3. The exhaust gas recirculation system according to claim 2, wherein:
the cam projection piece includes a low-strength part having lower strength than the cam base; and
the cam member further includes a bridge-shaped reinforcement part that connects a free end portion of the cam projection piece and the cam base.

4. The exhaust gas recirculation system according to claim 3, wherein the reinforcement part is located at such a position as not to interfere with the roller.

5. The exhaust gas recirculation system according to claim 2, wherein:
the cam projection piece includes a low-strength part having lower strength than the cam base; and
the cam member further includes a plate-shaped reinforcement part that covers an entire surface of the cam groove.

6. The exhaust gas recirculation system according to claim 5, wherein the reinforcement part is located at such a position as not to interfere with the roller.

7. The exhaust gas recirculation system according to claim 1, wherein the cam groove includes combination of a plurality of circular arc grooves having different curvature radii and curvature centers, so that the second valve is driven to rotate in a movement pattern different from the first valve in accordance with the rotation of the cam member.

8. The exhaust gas recirculation system according to claim 1, wherein the cam groove has a cam profile that is formed in a shape corresponding to a movement pattern of the second valve.

9. The exhaust gas recirculation system according to claim 1, wherein the link member further includes a pivot, which is inserted movably in the cam groove to receive the power of the actuator from the cam member via the roller.

10. An exhaust system for an internal combustion engine, comprising:
a housing that includes first and second passages, a communication passage, and a merging part which merges the first and second passages into the communication passage, at least one of the first and second passages communicating with an exhaust passage of the engine;
first and second valves that are accommodated rotatably in the housing and are configured to open or close the first and second passages, respectively;
an actuator that includes:
a motor which is a power source for driving the first and second valves; and
a deceleration mechanism that is configured to decelerate rotation of an output shaft of the motor and includes:
a motor gear coupled to the output shaft of the motor to be rotatable integrally therewith;
an intermediate gear engaged with the motor gear thereby to rotate; and
a final gear engaged with the intermediate gear thereby to rotate;
a cam member that is coupled with the first valve to be in synchronization therewith and that receives power of the motor from the deceleration mechanism thereby to rotate; and
a link member that is coupled with the second valve to be in synchronization therewith and that receives the power of the motor through the cam member thereby to rotate, wherein:
the cam member includes:
a cam base that is located to be rotatable integrally with the final gear and receives the power of the motor from the final gear thereby to rotate together with the first valve;
a cam frame that is configured to transmit the power of the motor to the link member and includes an overlapping part that overlaps with the motor or the motor gear; and
a cam groove which is formed inside the cam frame and along which to drive the link member to rotate in synchronization with the rotation of the cam member;
the link member includes a roller that is guided along the cam groove; and
the cam frame is formed as a result of elimination of at least a part unnecessary for movement of the second valve from the overlapping part.

11. The exhaust system according to claim 10, wherein:
the deceleration mechanism further includes an intermediate gear shaft that is disposed in parallel relative to the output shaft of the motor; and
the intermediate gear is supported rotatably by an outer periphery of the intermediate gear shaft.

12. The exhaust system according to claim 10, wherein:
the cam base includes a rotation center part of the cam member; and
the cam frame further includes:
an outer cam projection piece extending from one end side to the other end side of the cam groove in its formation direction radially outward of the cam base; and
an inner cam projection piece extending from an outer circumferential part of the cam base toward the other end side of the cam groove in its formation direction.

13. The exhaust system according to claim 12, wherein the cam groove is formed between the outer cam projection piece and the cam base, and between the outer cam projection piece and the inner cam projection piece.

14. The exhaust system according to claim 13, wherein the overlapping part of the outer cam projection piece that overlaps with the motor or the motor gear is entirely eliminated.

15. The exhaust system according to claim 14, wherein:
the outer cam projection piece and the inner cam projection piece respectively include open end parts on the other end side of the cam groove in its formation direction; and
the open end parts open outward of the cam frame.

16. The exhaust system according to claim 15, wherein a position of the open end part of the outer cam projection piece is set further on the one end side of the cam groove in its formation direction than a position of the open end part of the inner cam projection piece.

17. The exhaust system according to claim 15, wherein the open end part of the outer cam projection piece and the open end part of the inner cam projection piece open on a fully-closed position side of the second valve, so that the roller is guided along the cam groove to be located on the other end side of the cam groove in its formation direction when the second valve is fully closed.

18. The exhaust system according to claim 17, further comprising a valve holding means for holding the second valve at its fully-closed position.

19. The exhaust system according to claim 10, wherein the cam groove includes combination of a plurality of circular arc grooves having different curvature radii and curvature centers, so that the second valve is driven to rotate in a movement pattern different from the first valve in accordance with the rotation of the cam member.

20. The exhaust system according to claim 10, wherein the cam groove has a cam profile that is formed in a shape corresponding to a movement pattern of the second valve.

21. The exhaust system according to claim 10, wherein the link member further includes a pivot, which is inserted movably in the cam groove to receive the power of the motor from the cam member via the roller.

22. The exhaust system according to claim 10, wherein the exhaust system is adapted for an exhaust gas recirculation system for mixing exhaust gas of the engine into intake air and for recirculating mixed gas of the intake air and the exhaust gas to the engine.
